(19) United States
(12) Patent Application Publication
(10) Pub. No.: US 2016/0117224 A1
(43) Pub. Date: Apr. 28, 2016

(54) COMPUTER-READABLE RECORDING MEDIUM HAVING STORED THEREIN ANALYSIS PROGRAM, ANALYSIS APPARATUS, AND ANALYSIS METHOD

(71) Applicant: FUJITSU LIMITED, Kawasaki-shi (JP)

(72) Inventors: Yuuji HOTTA, Kawasaki (JP); Takeshi Yasuie, Kawasaki (JP); Atsuji SEKIGUCHI, Kawasaki (JP); Toshihiro SHIMIZU, Sagamihara (JP)

(21) Appl. No.: 14/832,111

(22) Filed: Aug. 21, 2015

(30) Foreign Application Priority Data
Oct. 22, 2014 (JP) 2014-215689

(51) Int. Cl. G06F 11/10; G06F 11/07

(52) U.S. Cl. CPC G06F 11/1076; G06F 11/073; G06F 11/079

(57) ABSTRACT

An analysis method including: storing information on modules through which each processing passes with respect to each of a plurality of processings in which shared modules exist; determining a normal or abnormal state of each of the processings which are performed during a predetermined time interval based on log information related to the plurality of processings which are performed during the predetermined time interval; correcting the information on the modules according to each of the processings which are performed during the predetermined time interval, based on a predetermined condition, when an abnormal module is not identified in a process of identifying the abnormal module by using a determination result of the normal or abnormal state and the information on the modules according to each of the processings; and identifying the abnormal module by using the determination result and the corrected information on the modules.

### CROSS-REFERENCE TO RELATED APPLICATION

This application is based upon and claims the benefit of priority of the prior Japanese Patent Application No. 2014-215689, filed on Oct. 22 2014, the entire contents of which are incorporated herein by reference.

### FIELD

The present inventions relates to a computer-readable recording medium having stored therein an analysis program, an analysis apparatus, and an analysis method.

### BACKGROUND

In an application program, a network service, or the like, attempts have been made to find a delay point or an abnormal point (see, for example, Patent Document 1 listed below).

A processing performed by an application program or a network component is realized by passing through a plurality of modules A to D, such as a processing sequence of start-A-B-C-D-end, and each of the modules may be used by a plurality of processings. Therefore, the application program or the network component performs a processing using a common module in the plurality of processings.

A delay of a particular module causes a delay in a plurality of relevant processings. To identify a module being delayed, the following technique is known (for example, see Patent Document 2 listed below).

For example, an analysis apparatus stores path information which identifies modules used by each of a plurality of processings from a result of performing the plurality of processings and extracts log information output during a predetermined time interval, which includes a time point at which a delay of a processing time is detected from the log information including processings and processing times. Therefore, the analysis apparatus can identify a module that causes a processing delay based on the extracted log information and the path information.
[Patent Document 1] Japanese Laid-open Patent Publication No. 2002-082926
[Patent Document 2] Japanese Laid-open Patent Publication No. 2014-132421

In the above-described technology, information on modules through which the plurality of processings pass (path information) is generated from the result of performing the processings in advance.

An analysis apparatus assumes that the path information generated in advance is correct, but there is a possibility that the generated path information is incorrect, in other words, a module identified by the path information is different from a module used in a processing included in extracted log information. Such a situation occurs when there is a different condition, such as, a performance timing or a designated parameter of each processing related to the path information or the log information, for example, when a different module is performed due to condition branch.

When the path information is not correct, the analysis apparatus is hard to identify a module used in processing included in the extracted log information and may have a difficulty to identify a module that is a cause of delay of processing.

### SUMMARY

According to an aspect of the embodiments, a computer-readable recording medium having stored therein an analysis program causes a computer to execute the following process. The process includes: storing information on modules through which each processing passes with respect to each of a plurality of processings in which shared modules exist; and determining a normal or abnormal state of each of the processings which are performed during a predetermined time interval based on log information related to the plurality of processings which are performed during the predetermined time interval. In addition, the process includes correcting the information on the modules according to each of the processings which are performed during the predetermined time interval, based on a predetermined condition, when an abnormal module is not identified in a process of identifying the abnormal module by using a determination result of the normal or abnormal state and the information on the modules according to each of the processings which are performed during the predetermined time interval. Furthermore, the process includes identifying the abnormal module by using the determination result of the normal or abnormal state and the corrected information on the modules.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a network system according to an embodiment;

FIG. 2 is a diagram illustrating an example of a relationship between functions and components according to an embodiment;

FIGS. 3A to 3D are diagrams illustrating an example of matrix expressions of the relationship between the functions and the components according to the embodiment;

FIG. 4 is a flowchart describing an example of an operation of an analysis phase according to an embodiment;

FIG. 5 is a flowchart describing an example of an operation of an operation phase according to an embodiment;

FIG. 6 is a flowchart describing an example of association processing illustrated in FIG. 4;

FIG. 7 is a diagram schematically describing an example of the association processing illustrated in FIG. 4;

FIG. 8 is a diagram illustrating an example of an analysis result notification window of the operation phase according to an embodiment;

FIG. 9 is a diagram illustrating an example of an analysis result notification window of the operation phase according to an embodiment;

FIG. 10 is a diagram schematically illustrating a state in which normal and abnormal data are mixed in an aggregation interval of each function according to an embodiment;

FIG. 11 is a diagram schematically describing an example of a problem when the aggregation interval is minimized in FIG. 10;

FIG. 12 is a diagram schematically describing a state in which a normal interval and an abnormal interval in FIG. 10 are divided and determined in a superimposed manner;

FIG. 13 is a diagram describing a case example of a business processing system according to an embodiment;

FIG. 14 is a diagram schematically describing an example of an abnormal development in the business processing system illustrated in FIG. 13;

FIG. 15 is a diagram schematically describing a case where the analysis method according to the embodiment is applied to the business processing system;

FIG. 16 is a flowchart describing advance preparation processing according to an embodiment;

FIG. 17 is a flowchart describing an example of an operation in an operation phase according to an embodiment;

FIG. 18 is a diagram illustrating a state in which unit of request-response data (RR data) is set as a determination interval in an embodiment;

FIG. 19 is a diagram illustrating a state in which normal RR data are merged and set as a normal interval, and abnormal RR data are merged and set as an abnormal interval;

FIG. 20 is a diagram illustrating a state in which an interval where RR data of switch of the normal interval and the abnormal interval does not exist is treated as no data in an embodiment;

FIG. 21 is a diagram illustrating a state in which an interval where RR data of switch of the normal interval and the abnormal interval does not exist is treated as no data in an embodiment;

FIG. 22 is a diagram illustrating a state in which an interval is switched at a timing where next RR data of switch of the normal interval and the abnormal interval appears in an embodiment;

FIG. 23 is a diagram illustrating a state in which an interval is switched at an end timing of the last RR data of the same type of RR data in an embodiment;

FIG. 24 is a diagram illustrating a state in which a switching is performed at a middle point of a normal RR data group and an abnormal RR data group;

FIG. 25 is a diagram illustrating a state of a case where RR data are superimposed in an embodiment;

FIG. 26 is a diagram illustrating a state in which an interval from the start to the end of the same type of RR data is set as one normal interval or abnormal interval in an embodiment;

FIG. 27 is a diagram illustrating a state in which an interval is separated at a start timing (appearance timing) of different types of next RR data in an embodiment;

FIG. 28 is a diagram illustrating a state in which an interval is switched is separated at an end timing of the previous type of the last RR data before appearance of different types of RR data in an embodiment;

FIG. 29 is a diagram illustrating a state in which an interval is cut as a normal interval at the start of normal RR data, and an interval is cut at the end of normal RR data;

FIGS. 30A and 30B are comparative diagrams illustrating a state in which RR data of a part of a function does not appear in different timings in an embodiment;

FIGS. 31A and 31B are diagrams illustrating a comparison between a case where only one RR data appears and a case where a plurality of RR data appears, in different timings in an embodiment;

FIGS. 32A to 32C are diagrams schematically describing a concrete conflict and an implicit conflict according to an embodiment;

FIG. 33 is a diagram illustrating an example of a relationship between functions and components according to an embodiment;

FIG. 34 is a flowchart describing a generation of a supplementary table (exclusive point table) in an embodiment;

FIGS. 35A and 35B are diagrams illustrating an example of a path information table and an exclusive point table according to an embodiment;

FIG. 36 is a supplementing flowchart according to an embodiment;

FIG. 37 is a diagram illustrating an example of a relationship between functions and components according to an embodiment;

FIG. 38 is a diagram illustrating an example of frequency information (table) according to an embodiment;

FIG. 39 is a flowchart describing an example of function selection processing according to an embodiment;

FIG. 40 is a diagram illustrating an example of a relationship between functions and components according to an embodiment;

FIG. 41 is a diagram illustrating an example of frequency information (table) according to an embodiment;

FIG. 42 is a diagram illustrating an example of frequency information (table) according to an embodiment;

FIGS. 43A and 43B are diagrams illustrating a case where path information is different from execution content of processing in an operation phase according to an embodiment;

FIG. 44 is a diagram illustrating an example of correction of path information according to an embodiment;

FIG. 45 is a diagram illustrating an example of correction of path information according to an embodiment;

FIG. 46 is a diagram illustrating an example of correction of path information according to an embodiment;

FIG. 47 is a diagram illustrating an example of correction of path information according to an embodiment;

FIG. 48 is a flowchart describing processing for correction of path information and re-performance of identification of a problem point according to an embodiment;

FIG. 49 is a diagram illustrating an example of an access log according to an embodiment;

FIG. 50 is a diagram illustrating an example of a normal or abnormal state for each function in path information according to an embodiment;

FIG. 51 is a flowchart describing processing of managing path information according to an embodiment;

FIG. 52 is a diagram illustrating an example of a correction frequency of each pattern of corrected path information according to an embodiment;

FIG. 53 is a diagram illustrating an example of an analysis result notification window of the operation phase according to an embodiment;

FIG. 54 is a diagram illustrating an example of an analysis result notification window of the operation phase according to an embodiment;

FIG. 55 is a diagram illustrating an example of a method for calculating reliability used in correction of path information according to an embodiment;

FIG. 56 is a diagram illustrating an example of a method for calculating reliability used in correction of path information according to an embodiment;

FIG. 57 is a diagram illustrating an example of a correction target component according to an embodiment; and

FIG. 58 is a diagram illustrating an example of an analysis result notification window of the operation phase according to an embodiment.

### DESCRIPTION OF EMBODIMENTS

Hereinafter, embodiments will be described with reference to the drawings. However, the embodiments to be described below are merely exemplary and are not intended to exclude a variety of unspecified modifications or technical applications. Note that, in the drawings referred to in the following embodiments, parts assigned with the same reference numerals indicate the same or similar parts unless otherwise particularly mentioned.

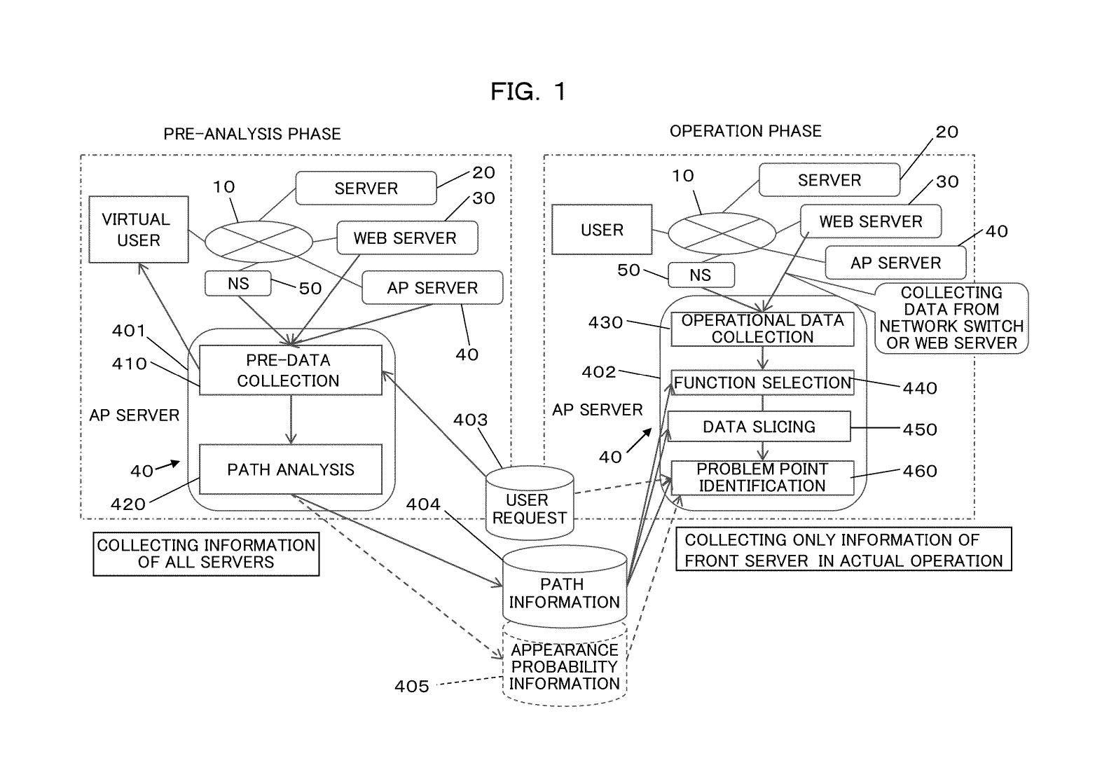

FIG. 1 is a block diagram illustrating an example of a network system according to an embodiment. The network system illustrated in FIG. 1, for example, includes a network 10 such as Internet or the like, server groups 20, 30 and 40 connected to the network 10, and a network switch (NS) 50. The server groups 20, 30 and 40, for example, include a web server 30 or, an application (AP) server 40, other server 20, and the like.

The AP server 40, for example, includes a pre-analysis block 401, an operation block 402, a user request database 403, and a path information database 404. Optionally, the AP server 40 may include an appearance probability database 405.

The AP server 40 may include a Central Processing Unit (CPU), a memory, such as a Random Access Memory (RAM) or the like, a storage device, such as a hard disk device, a display device, a printer, and the like (which are not illustrated in the drawings), as an example of a processing unit (not illustrated). In the AP server 40, the CPU implements a necessary function unit by reading and operating a predetermined program from the memory or the storage device. For example, the program includes an analysis program as an example of the program that implements the function of the pre-analysis block 401 or the operation block 402. The display device or the printer, for example, may output the results of operations by the CPU. Note that, other server 20 or the web server 30 may include a CPU, a memory, a storage device such as a hard disk device or the like, a display device, and a printer as hardware devices.

The function of the analysis program (all or partial function of each unit) is implemented in such a manner that a processing unit, such as, the CPU or the like executes the predetermined program.

The program, for example, is provided in a form of being stored in a computer-readable recording medium such as a floppy disk, a Compact Disc-Read Only Memory (CD-ROM), a CD-R, a CD-RW, an Magneto-Optical Disc (MO), a Digital Versatile Disc (DVD), a blue-ray disk, a portable hard disk, a Universal Serial Bus (USB) memory, or the like. In this case, the computer (processing unit of the computer) uses the program that is read from the recording medium, transmitted to an internal storage device or an external storage device, and stored in the storage device. Also, the program, for example, may be stored in a storage device (recording medium) such as a magnetic disk, an optical disk, an optical magnetic disk, or the like, and provided to the computer (information processing apparatus), such as the AP server 40, from the storage device via a communication line.

In addition, the computer, such as the AP server 40, can include means to read the program stored in the recording medium.

The application program includes a program code executing the functions of the analysis program in the computer as described above. Also, a part of the function may be implemented by not the application program but the Operating System (OS).

Also, the recording medium may use a variety of computer-readable media such as an Integrated Circuit (IC) card, a ROM cartridge, a magnetic tape, a punch card, an internal storage device (memory such as a RAM or a ROM) of the computer, an external storage device of the computer, or a printed matter with a printed code such as a bar code, in addition to the floppy disk, the CD-ROM, the CD-R, the CD-RW, the DVD, the magnetic disk, and the optical magnetic disk as described above.

The user request database 403, the path information database 404, and the appearance probability database 405, for example, are implemented in the memory or the storage device of the AP server 40.

The pre-analysis block 401, for example, includes a pre-data collection unit 410 and a path analysis unit 420.

The pre-data collection unit 410 inputs (transmits) data (request or the like) of the user request database 403 to the network 10 as virtual user data. Note that, the pre-data collection unit 410 may store an actual request, state, and the like of an actual operation and reproduce an operational state of an actual operation.

The path analysis unit 420, for example, collects message data flowing through the respective servers 20, 30 and 40 as the result by the input of the virtual user data, performs the path analysis, and stores the analysis result in the path information database 404 as the path information.

The operation block 402, for example, includes an operational data collection unit 430, a function selection unit 440, a data slicing unit 450, and a problem point identifying unit 460.

The operational data collection unit 430 collects, for example, Uniform Resource Locator (URL)+Common Gateway Interface (CGI) parameter or the like from data flowing through the servers 20, 30 and 40 during the actual operation in the operation phase as, for example, log data. Note that, in the actual operation, only information of a “front server” may be collected. The “front server” refers to a server closest to the user side, which receives the request from the user, as compared with “all servers” in the pre-analysis phase. In the configuration illustrated in FIG. 1, the web server 30 may correspond to the “front server”. However, depending on the configuration, a load distribution server (load balancer; not illustrated) may correspond to the “front server”, and the AP server 40 may correspond to the “front server”.

The function selection unit 440 compares the collected log data with the path information of the path information database 404, and perform the function selection (classification) of the log data.

The data slicing unit 450 performs processing of cutting a time interval in which normal and abnormal states are not mixed in each selected function (processing of calculating a state change timing). Details will be described below.

The problem point identifying unit 460 performs a delay detection in the time interval cut by the data slicing unit 450, and narrows or identifies a problem point by comparison with the path information when the delay is detected. There is a case where it is hard to narrow or identify a problem point when the path information is incorrect. In this case, the problem point identifying unit 460 may perform comparison with the path information after correction during a time interval in which delay id detected, and narrow or identify the problem point, by performing correction or re-generation (hereinafter, collectively referred to as “correction”) of the path information according to the below-described method.

The “functions” (or “processings”) as used herein are classified as follows.

First, captured actual data is collected or data is collected by reproducing (replaying) test data by the pre-data collection unit 410, and the path analysis unit 420 classifies the path of each function of the system.

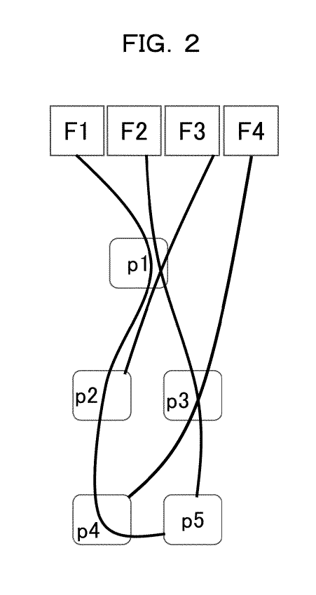

For example, as illustrated in FIG. 2, when p1 to p5 are assumed as network components, message data flowing through the respective components p1 to p5 are analyzed, and the functions (Fi: i is a natural number) are classified by the URL+CGI parameter. It can be seen that the respective functions pass through the following paths. Note that, the components p1 to p5 may be processed as method unit or block unit of program. The term “component” may be replaced with the term “module” or “check point”. Also, the “path” is positioned as a set of “components”. In addition, the path information stored in the path information database 404 can be information in which a function Fi as described below is associated with one or more components which the function passes through (uses), that is, a path, as an example.
F1=//foo.com/appli1.cgi?flag=exec path=p1-p2-p4-p5
F2=//foo.com/appli1.cgi?flag=calc path=p1-p3-p5
F3=//foo.com/appli1.cgi?data=true path =pl-p2
F4=//foo.com/appli2.cgi?feature=3 path=p3-p4
(“http:”s are omitted from the above URLs)

When F1 and F2 are delayed more than usual, the problem point identifying unit 460 may determine in view of the analyzed path information that the paths (check points) p1, p2, p3, p4 and p5, through which F1 and F2 pass, have problem (abnormality) probability.

Also, for example, it may be determined that there are no problems in the common paths p1, p2, p3 and p4 of F1, F2 and F3 by information indicating that F3 and F4 are not delayed and path information of F3 and F4. As a result, the remaining path p5 may be diagnosed as the cause of the delay.

Note that, when the analysis target is a program, p1 to p5 may be processed as method (function) call unit, block unit, log output point unit designated by a user, or a combination thereof, as exemplarily described below.
method (function) call unit
p1=method1( )→p2=method2( )→p4=method3( ), . . .
   block unit (blocks divided by if statement or { })
p1=while( . . . )→p2=if( ) . . . →p4=else . . .
   log output point designated by user
p1={file=foo.java, line=35}→p2={file=foo.java, line=55}→p4={file=boo.java, line=20} etc.

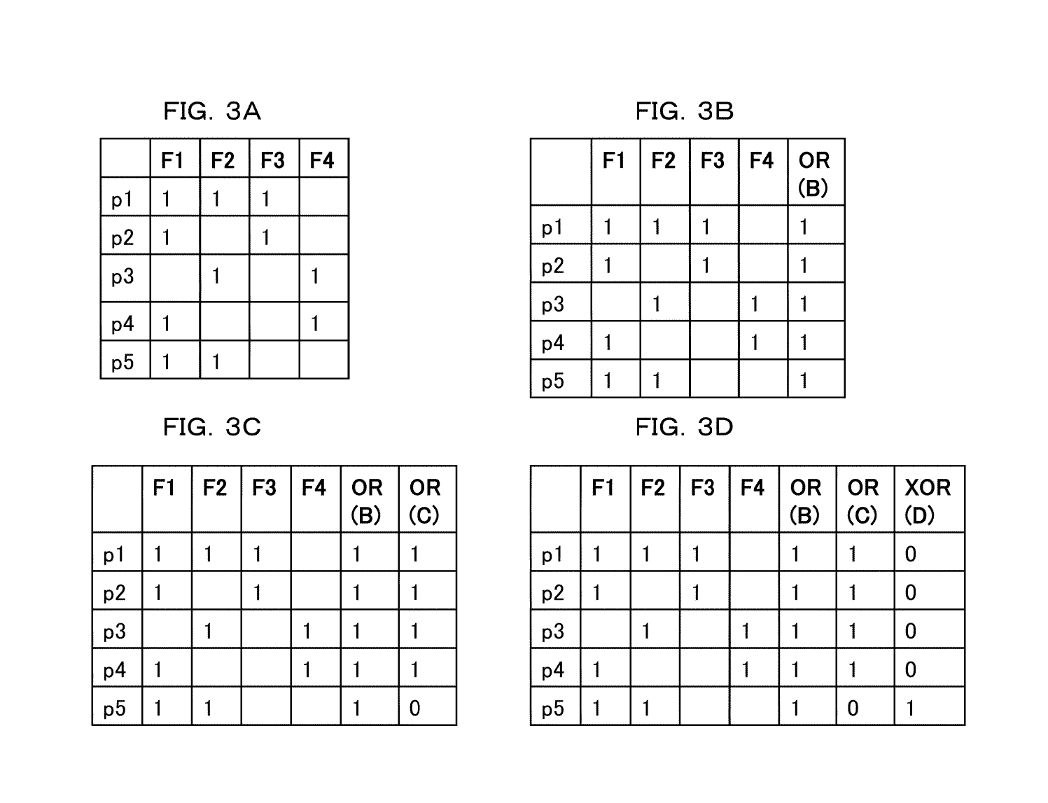

As a simple example, as illustrated in FIG. 3A, the path information may express the respective functions F1 to F4 and the check points p1 to p5 in a matrix. Note that, the matrix expression is an example of processing in the analysis phase.

As illustrated in FIG. 3B, the chick points of the deteriorated functions (F1 and F2 in the example of FIG. 2) are detected by a logical sum (OR). Next, as illustrated in FIG. 3C, the check points of the non-deteriorated functions (F3 and F4 in the example of FIG. 2) are detected by OR.

Further, as illustrated in FIG. 3D, an exclusive logical sum (XOR) is performed on the result of FIG. 3B and the result of FIG. 3C. Next, a logical product (AND) is performed on the result of FIG. 3B and the result of FIG. 3D. In the present example, the result of AND is identical to that of FIG. 3D. As illustrated in FIG. 3D, p5, in which “1” remains, may be identified as the problem point, based on the result of AND.

(Analysis Phase)

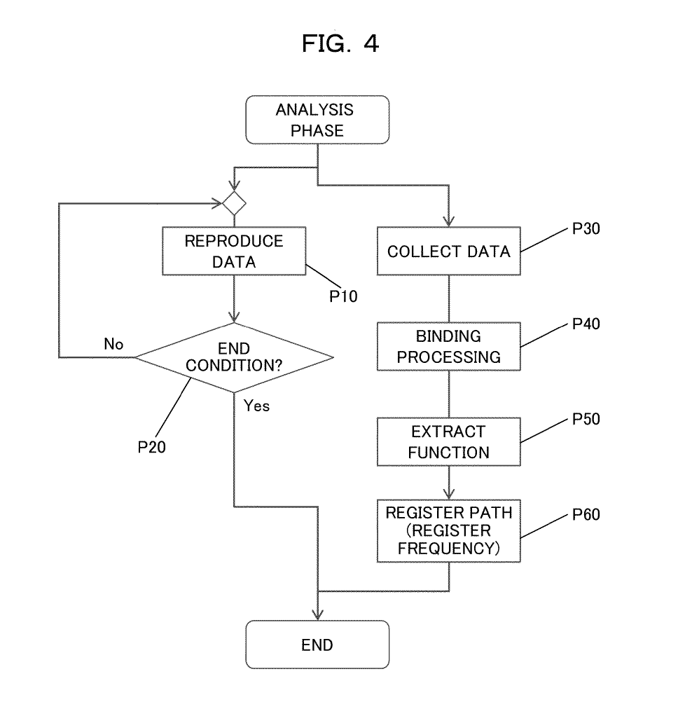

As illustrated in FIG. 4, in the analysis phase (analysis block 401), two functions may be executed in parallel.

First, in the analysis block 401, the pre-data collection unit 410 inputs a request message to the servers 20, 30 and 40 by reproducing request data prepared in advance in the user request database 403 (data reproduction: processing P10). The processing is repeated until a predetermined end condition is satisfied (until determined as Yes in processing P20) (No route of processing P20). Note that, as the request data, those collected in the actual operation, those generated as test data, or the like may be used.

The pre-data collection unit 410 acquires data by capturing network data called by the data input in the data reproduction or by acquiring log data of the servers 20, 30 and 40 (processing P30).

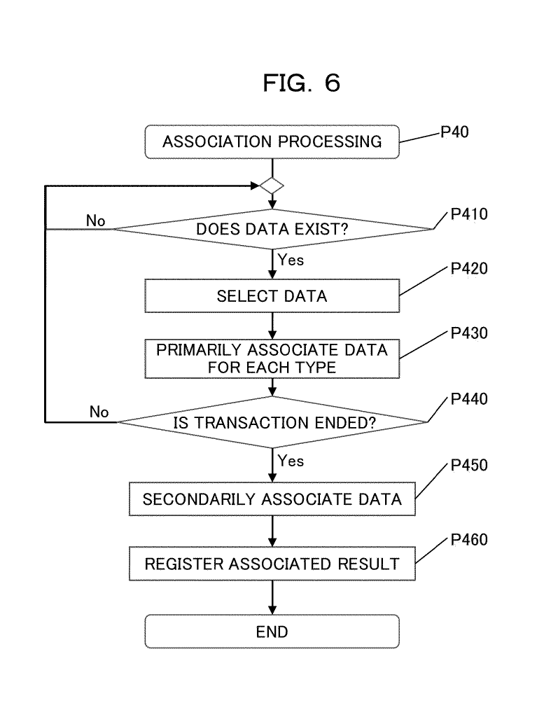

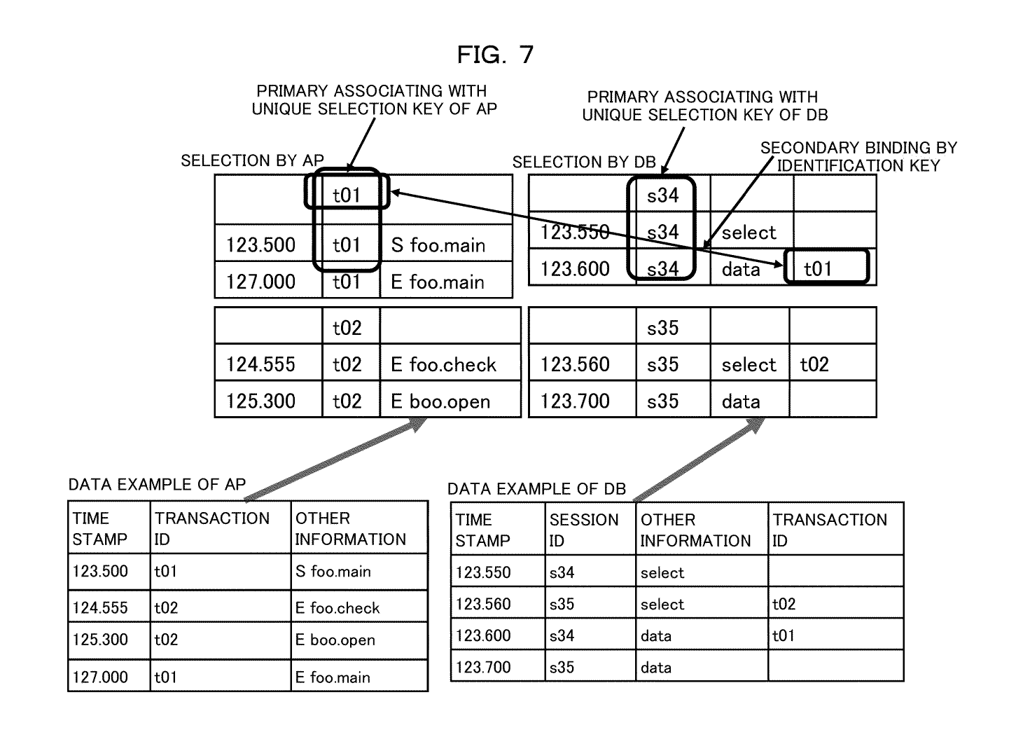

Next, in the analysis block 401, for example, the path analysis unit 420 performs association processing on the acquired data and generates path information (processing P40). An example of the association processing is illustrated in FIGS. 6 and 7.

As illustrated in FIG. 6, the path analysis unit 420 checks whether data to be associated exist (processing P410). When the data does not exist, the path analysis unit 420 waits until data appears (No route of processing P410), and when the data exits, the path analysis unit 420 selects a data type (application or database, and the like) (processing P420 in Yes route of processing P410).

Next, the path analysis unit 420 performs primary association processing on each selected type (processing P430). Further, the path analysis unit 420 checks whether a transaction is ended (processing P440). When all constituent data types of data are provided, it is determined as the transaction end (Yes route of processing P440), and the path analysis unit 420 performs secondary association processing on all constituent data types of data by using an identification key (processing P450). Note that, processings subsequent to processing P410 are repeated until it is determined as the transaction end (No route of processing P440).

FIG. 7 illustrates an example of the primary association processing and the secondary association processing. On the lower left side of FIG. 7, a data structure including a time stamp, a transaction ID, and other information is illustrated as a data example of the application (AP). Meanwhile, on the lower right side of FIG. 7, a data structure including a time stamp, a session ID, other information, and a transaction ID is illustrated as a data example of the database (DB).

The upper side of FIG. 7 illustrates a state in which data illustrated on the lower side of FIG. 7 are selected for each data type. Further, as illustrated on the upper side of FIG. 7, the data of the AP are primarily bound by a unique selection key of the AP (for example, the transaction ID (t01, t02, and the like), and the data of the DB are primarily associated by a unique selection key of the DB (for example, the session ID (s34, s35, and the like).

Different types of data are secondarily associated by an identification key (for example, the transaction ID (t01, t02, and the like). Note that, all data do not necessarily have identification keys that are needed for the secondary association.

When the secondary association is completed, the path analysis unit 420 registers (stores) the associated result (processing P460).

When such association processing is completed, the path analysis unit 420 performs function extraction processing as illustrated in FIG. 4 (processing P50). The function extraction processing is an example of processing of extracting and classifying the functions from the above associated result and the URL+CGI parameter.

The path analysis unit 420 registers the analysis result in the path information database 404 as the path information (processing P60). Note that, as described below, in order to improve the accuracy of the problem point identification, a method using appearance probability (frequency) information may be considered. In this case, the path analysis unit 420 stores the appearance probability information in the appearance probability information database 405 (see FIG. 1).

(Operation Phase)

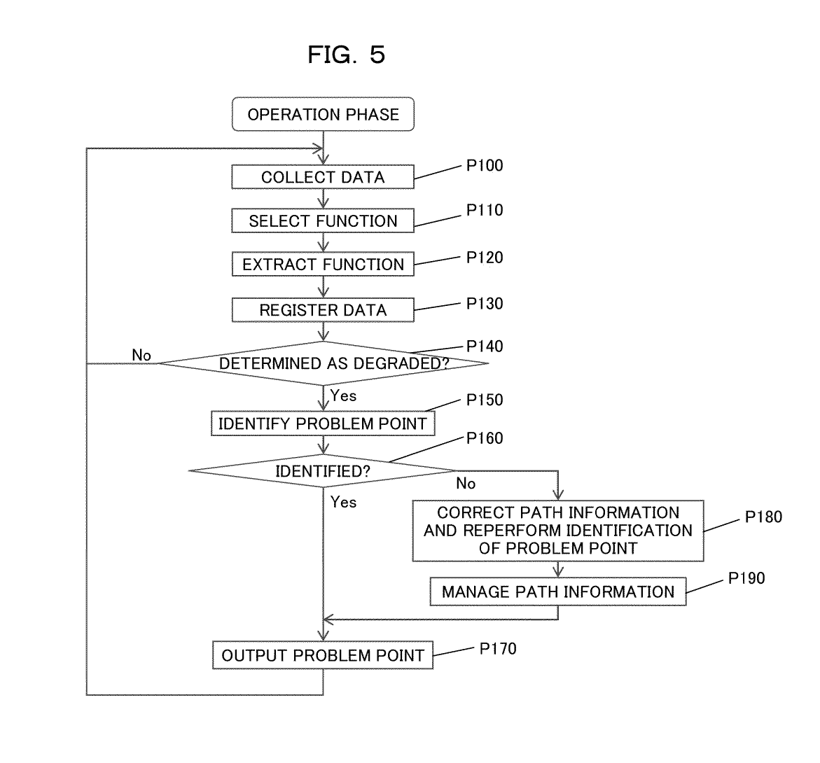

Next, an example of processing in the operation phase will be described with reference to FIG. 5.

In the operation phase (operation block 402), the operational data collection unit 430 collects information such as the URL+CGI parameter and the response time among the actual operational data from the network switch 50 or the web server 30 (processing P100).

Next, in the operation block 402, the function selection unit 440 selects function units from the collected data, based on the parameters such as URL, CGI, and the like (processing P110).

Further, in the operation block 402, the data slicing unit 450 performs function extraction processing, that is, processing of cutting a time interval in which normal and abnormal states are not mixed in each selected function (processing of calculating a state change timing) (processing P120). Note that, when the selected function is not included in the path information, it is applied to the function of the path information.

Thereafter, the data slicing unit 450 registers (stores) the function and response information in an analysis target data table (not illustrated) as aggregation information (processing P130). An example of a registration form is illustrated in Table 1 below.

TABLE 1
Example of registration form of analysis data table

| | Separation: Normal/Abnormal | |
|---|---|---|
| Function | (Normal = 0, Abnormal = 1) | Interval ID |
| F1 | 1 | 12 |
| F2 | 0 | 12 |
| F3 | 0 | 12 |
| . . . | . . . | . . . |

In the example of Table 1 above, an entry in which data appears in an interval identified by the interval ID is registered. F3 represents that no data has existed in that interval. Note that, the interval information corresponding to the interval ID, for example, may be managed in other table (interval table) illustrated in Table 2 below. A length of the interval may be different at each slice.

TABLE 2
Example of interval table

| Interval ID | Start Time | End Time |
|---|---|---|
| 11 | 123.333 | 123.555 |
| 12 | 123.580 | 134.222 |
| . . . | . . . | . . . |

Next, in the operation block 402, the problem point identifying unit 460 determines whether the response is degraded (processing P140). The determination may be performed in single response unit or aggregation unit.

When the response is not degraded, the operation block 402 repeats the processings subsequent to processing P100 (No route of processing P140). On the other hand, when the response is degraded (Yes in processing P140), the problem point identifying unit 460 performs the problem point identification by comparing the aggregation information and the path information (processing P150).

When the problem point identification is possible (Yes route of processing P160), the problem point identifying unit 460 outputs the information of the identified problem point on the display device or the like (processing P170). At this time, when a plurality of candidates exists, the plurality of candidates may be output after assigning priorities thereto. However, the assignment of the priorities may be omitted.

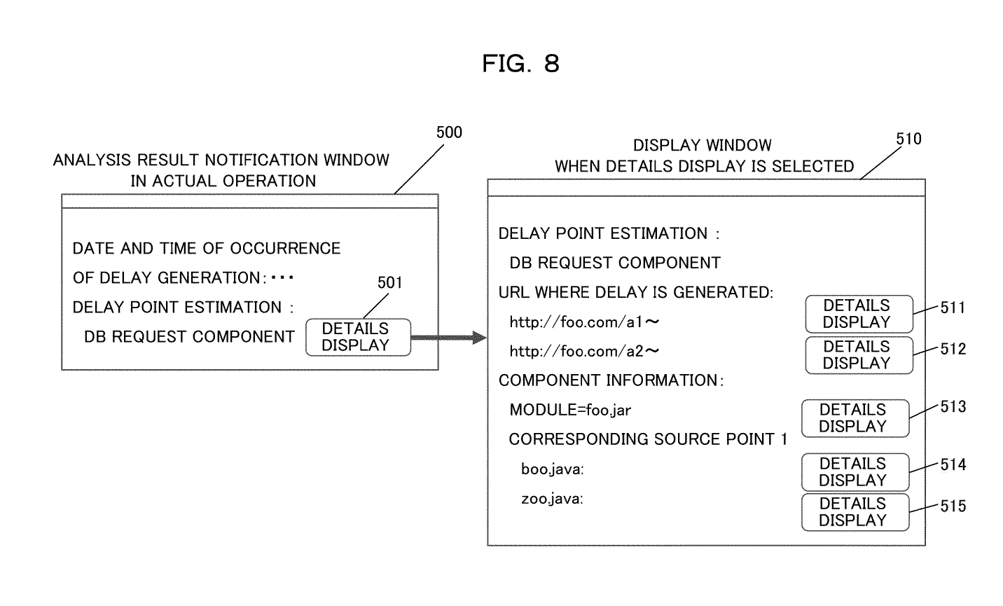

An example of output data is illustrated in FIG. 8. An example of an analysis result notification window 500 in the actual operation phase is illustrated on the left side of FIG. 8. For example, information such as a date and time of delay generation, an estimated delay point, and the like is displayed on the notification window 500.

Herein, when wanting to know more information about the delay point, a details display window 510 illustrated on the right side of FIG. 8 may be displayed, for example, by selecting a details display button 501 provided on the notification window 500. On the details display window 510, details display buttons 511 to 515 may also be disposed corresponding to the information to be displayed. When wanting to know more information on the details display window 510, more information may be displayed by selecting the corresponding details display buttons 511 to 515.

When the problem point identification is impossible (No route of processing P160), the problem point identifying unit 460 performs correction of the path information and performs identification of a problem point similarly to processing P150 based on the path information after correction (processing P180). At this time, the problem point identifying unit 460 may perform storage of the corrected path information (accumulation), updating of the path information of the path information database 404, or the like (processing P190).

When the problem point is identified by correction of the path information, the problem point identifying unit 460 outputs information on the identified problem point to a display device or the like (processing P170).

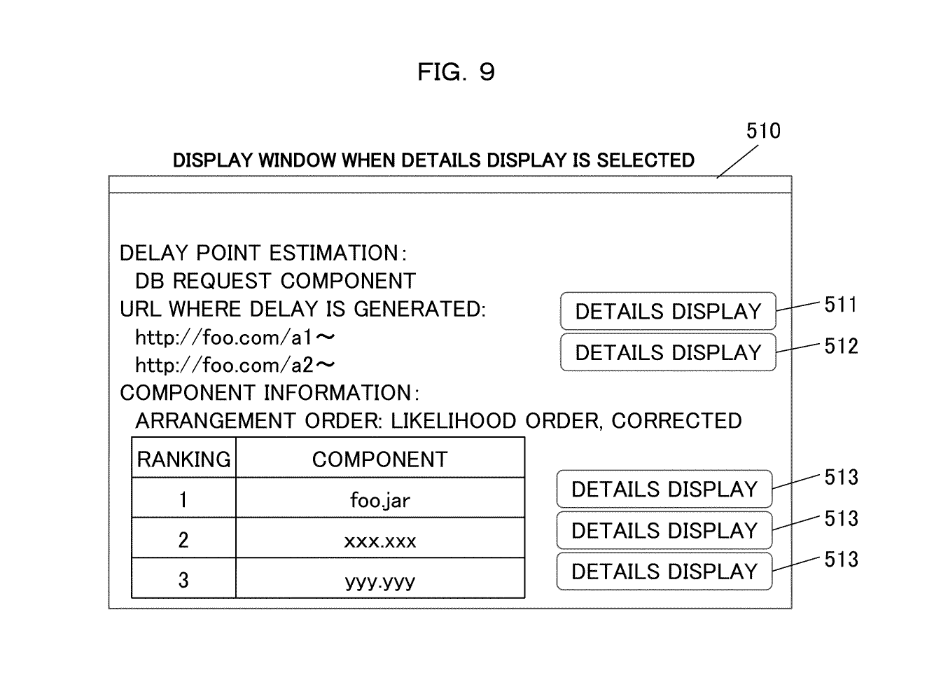

FIG. 9 illustrates another example of the details display window 510. As illustrated in FIG. 9, when there is a plurality of candidates as a component of a delay point, the plurality of components may be output on the details display window 510, for example, according to a descending order of possibility of being a delay point. In addition, when the path information is corrected, “corrected” may be displayed on the details display window 510 (or the notification window 500), which represents that the path information is a result of being corrected (revised) because of occurrence of inconsistency.

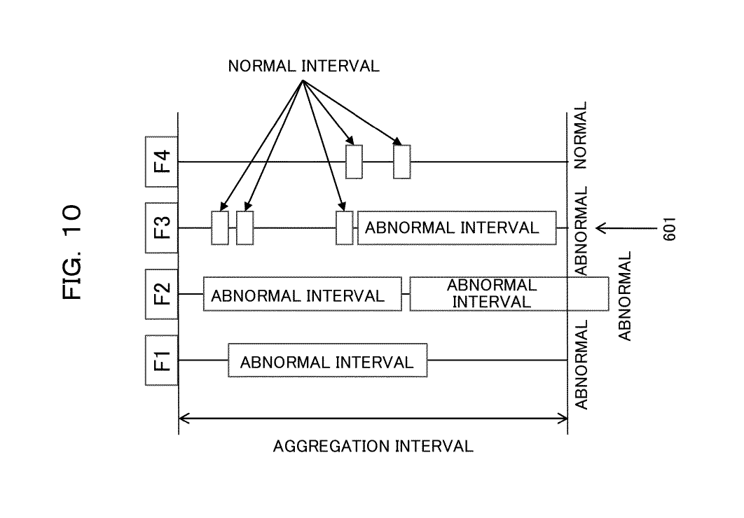

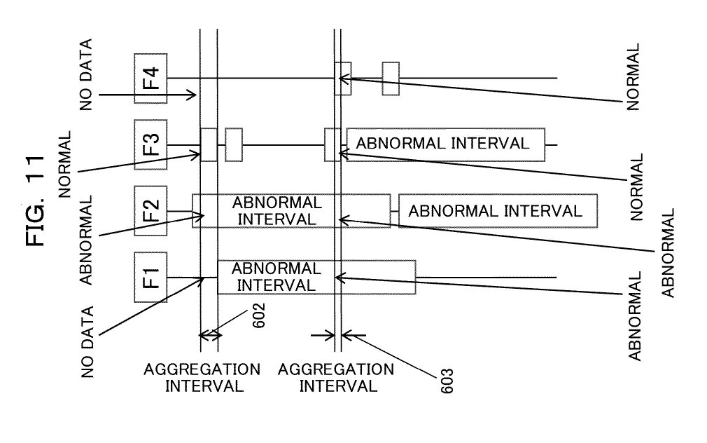

Next, in connection with processing P120 and P130 of FIG. 5, a problem when normal and abnormal data are mixed will be described with reference to FIGS. 10 and 11.

In FIGS. 10 and 11, “abnormal interval” illustrates “time interval of abnormal data”, and “normal interval” illustrates “time interval of normal data”. The “abnormal data”, for examples, refers to data representing that a response time (processing time of the collected log data) is longer than a normal range, and the “normal data”, for example, refers to data representing that a response time is within a normal range.

Even in the same functions, normal data and abnormal data may be mixed depending on timings. In that case, the aforementioned narrowing using the matrix cannot be performed.

For example, when a threshold value of the response time is 1 second (abnormal if equal to or more than 1 second, and normal if less than 1 second), the analysis may be imprecision even if the average 1 second is determined as abnormal (see, for example, an arrow 601 of FIG. 10). As such, when there is a problem caused by a dedicate matter of timing, a determination may be imprecision because the determination result becomes either normal or abnormal on average. Also, when response times of the plurality of functions (F1, F2, . . . ) are all around the threshold value, the analysis result may be never reliable. Since, in analysis of a malfunction of a network equipment, a normal state and an abnormal state are clearly divided, possibility that the mixture of normal/abnormal data occurs is low.

The data, in the data slicing unit 450 automatically seperates the region (time interval) in which the normal and abnormal states are not mixed, allowing for narrowing.

As an example of the basic processing, first, a timing of a change of the normal and abnormal states is calculated by each URL, and a time interval in which the normal and abnormal states are not mixed is separated by each URL, based on the corresponding timing. In a range where each time interval is superimposed, a matrix is made and an operation is performed (an abnormal module being a problem point is calculated (detected), based on “relationship information” between the plurality of processings (or functions) and the modules).

Note that, the “relationship information” (path information) may be appropriately updated. For example, the request data in the actual operation phase is stored in the user request database 403, and when unknown data having not appeared in the pre-analysis phase appears in the actual operation phase, the “relationship information” is updated by performing the pre-analysis again by using the stored request data.

However, if the interval in which the normal and abnormal states are not mixed in one URL is cut by a plurality of URLs, the interval is cut into too small pieces and thus combinations (computation time) become enormous. Therefore, among processings exemplified in the following (a) to (c), the abnormal point narrowing is performed by only (a), (a)+(b), (a)+(c), or (a)+(b)+(c).

(a) A slice that does not include an abnormal state is excluded.

(b) An operation is performed by selecting a slice that covers more points (components) (for example, since the component used by the URL is already known (analyzed), a slice including more components by combination is selected. Candidates of the combination are prepared by previously calculating “can most components be included if which combination of URLs is covered”.

(c) A slice that covers more URLs is selected and an operation is performed.

(Solution to Minimize Aggregation Interval)

Although wanting to make the corresponding operation applicable by adjusting the aggregation interval, effective data cannot be found by merely shortening the aggregation interval. If the aggregation interval is excessively shortened, functions (URLs) appearing at the same time are reduced and thus the analysis is not effective. Also, if data suitable for the analysis in various durations are found while changing the duration, the combinations are exploded and an estimate of a computation amount becomes impossible.

For example, as indicated by reference numeral 602 in FIG. 11, when the aggregation interval is shortened, data necessary for the determination (in this case, F1, F2, F3 and F4) are incomplete. Also, as indicated by reference numeral 603 in FIG. 11, when the aggregation interval is more shortened and the search is performed while sliding the corresponding aggregation interval, the interval necessary for the analysis may be found by change according to timings. However, the combinations become infinite and the computation time is lacking.

(Determination in Superimposed Manner by Separating Normal Interval and Abnormal Interval)

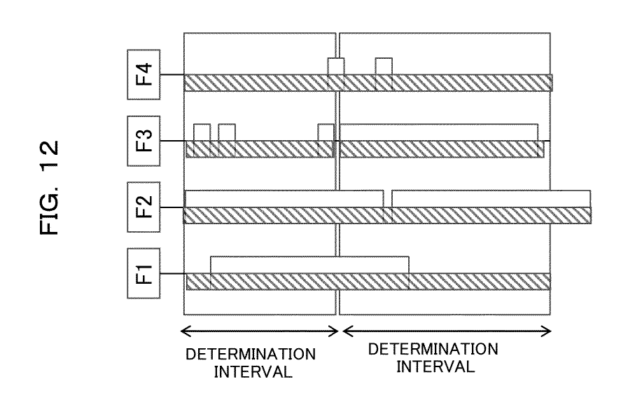

For example, as illustrated in FIG. 12, the data slicing unit 450 divides the normal interval and the abnormal interval at each function (for example, URL), and uses the superimposed region of the intervals for analysis. Therefore, analyzable data can be found with suppressing a computation amount, and analysis accuracy is improved. Note that, in FIG. 12, the functions F1 and F4 are assumed that similar abnormal or normal data exist before and after temporally. Further, FIG. 12 illustrates a state in which the interval (determination interval) is divided into two intervals by data of the function F3.

(Case Example in Business Processing System)

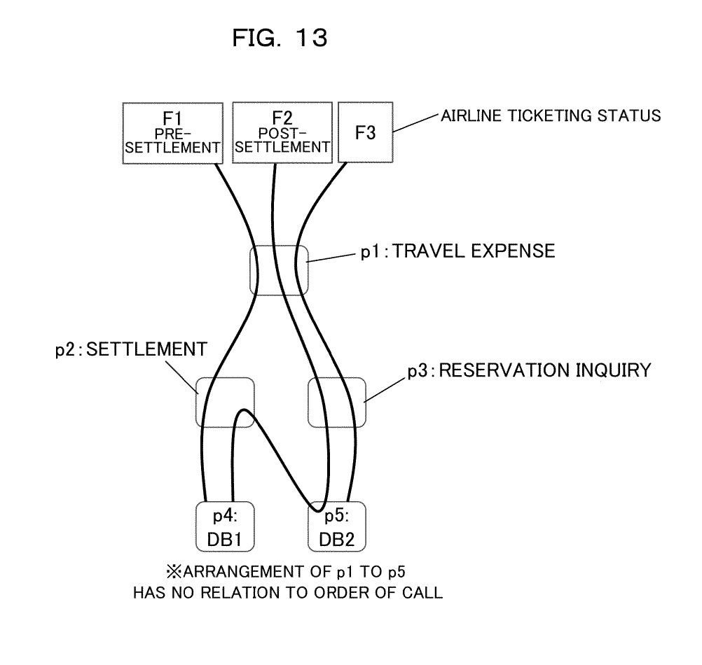

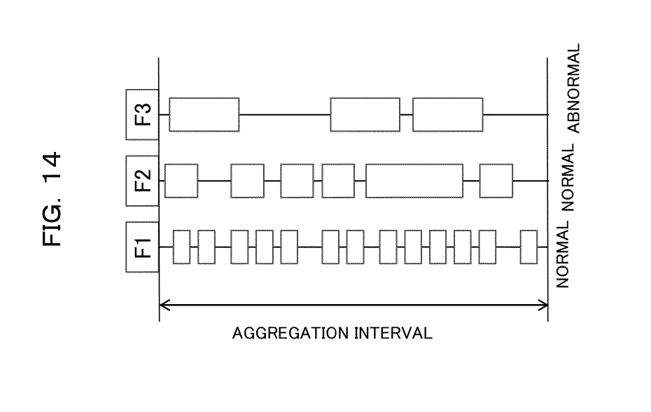

A problem occurring when a new service (airline ticketing system) of a business processing system is provided will be described with reference to FIGS. 13 and 14.

FIG. 13 illustrates a state in which functions (F1, F2 and F3) and paths are set as described below.
F1=pre-settlement path=p1 (travel expense)-p2 (settlement)-p4(DB1)
F2=post-settlement path=p1 (travel expense)-p3 (reservation inquiry)-p5 (DB2)-p2 (settlement)-p4 (DB1)
F3=airline ticketing status path=p1 (travel expense)-p3 (reservation inquiry)-p5 (DB2)

There has been no problems at the beginning of the system operation, but slowdown of the system occurred after one month. The direct cause is the increase in the load of the reservation inquiry (p3) by the airline ticketing status (F3) and the post-settlement (F2) because the search of all cases is performed in the reservation inquiry (p3) and the reservation inquiry (p3) is performed regardless of the existence and non-existence of the airline ticketing in the post-settlement (F3) of the travel expense.

Since an operator cannot imagine the increase in the load of the airline reservation inquiry (p3) due to the post-settlement, it has taken a long time to separate problems.

(Occurrence of Symptom in Business Processing System)

For example, as illustrated in FIG. 14, in a usual aggregation interval, since F1, F2 and F3 are classified into F1=normal, F2=normal, and F3=abnormal, the analysis is not correctly performed. If F1=normal, F2=abnormal, and F3=abnormal, the determination is possible.

### Diagnosis by the Present Embodiment

Advance Preparation

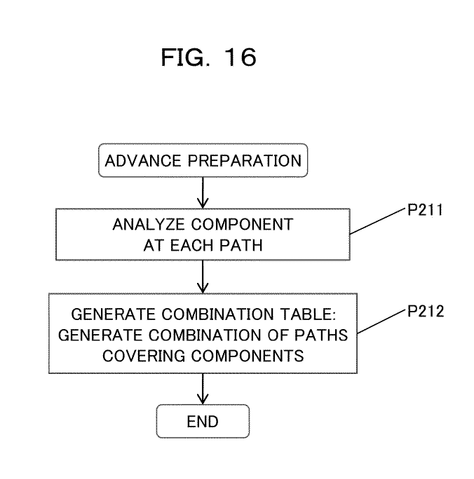

First, the path analysis unit 420 (see FIG. 1) of the pre-analysis block 401 classifies the businesses and/or functions by URL (+ argument) (F1 to F3), and sets path information at each classified business and/or function (processings P211 and P212 of FIG. 16). For example, as described below, the components p1 to p5 are set at each of the functions F1 to F3.

F1=//foo/ . . . pre-settlement:p1-p2-p3

F2=//boo/ . . . post-settlement:p1-p2-p3-p4-p5

F3=//bar/ . . . airline ticketing status:p1-p3-p5 (“http:”s are omitted from the above URLs)

Overview of Diagnosis

In a case where F1 is normal and F2 and F3 are delay, abnormal components are diagnosed. In a case where F2 and F3 are abnormal, it may be determined from the path information of F2 and F3 that there is a probability that p1, p2, p3, p4 and p5 (that is, all components in the case of the present example) are abnormal. Herein, since F1 is normal, the probability that p1, p2 and p4 are abnormal from the path information of F1 is excluded.

As a result, p3 (reservation inquiry) and p5 (DB2) are diagnosed as the cause of the delay. Note that, with respect to the abnormal components primarily separated by the diagnosis, a prompt attention is enabled by automatically performing additional monitoring or analysis.

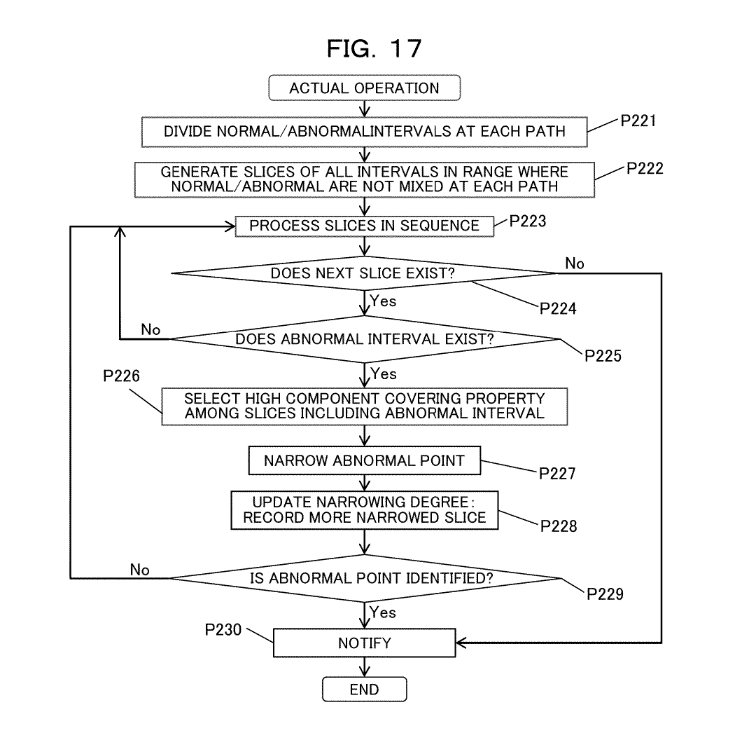

FIG. 17 illustrates an example of processing flow in the actual operation phase.

First, the data slicing unit 450 classifies the normal interval and the abnormal interval at each path (processing P221), and generates slices of all intervals in a range where the normal interval and the abnormal interval are not mixed at each path (processing P222).

Next, the problem point identifying unit 460 (see FIG. 1) processes the slices in sequence (processing P223). The problem point identifying unit 460 checks whether a next slice exists (processing P224). When the next slice exists (Yes in processing P224), the problem point identifying unit 460 determines whether an abnormal interval exists in the corresponding slice (processing P225). When the abnormal interval exists (Yes in processing P225), the problem point identifying unit 460 selects a slice having a high component coverage among the slices including the abnormal interval (processing P226), and narrows the abnormal point (processing P227).

The problem point identifying unit 460 updates a narrowing degree and records a more narrowed slice (processing P228). Next, the problem point identifying unit 460 determines whether the abnormal point can be identified (processing P229). When the abnormal point can be identified (Yes in processing P229), the problem point identifying unit 460 performs notification processing for example, by displaying information of the identified abnormal point on the display device or the like (processing P230).

Note that, when the abnormal interval is not included in the slice (No in processing P225) or when the abnormal point cannot be identified (No in processing P229), all processings proceed to processing P223. Meanwhile, when the next slice does not exist (No in processing P224), the notification processing is performed.

(Application to Business Processing System)

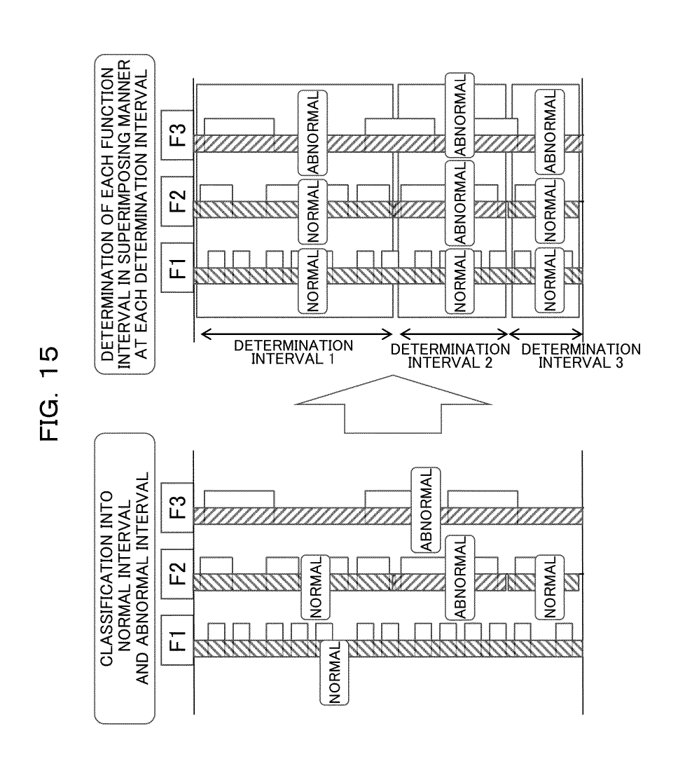

For example, as illustrated in FIG. 15, the normal interval and the abnormal interval are classified, and the determination is performed on each function interval in a superimposed manner at each determination interval. In the case of FIG. 15, “determination interval 1”=“normal, normal, abnormal”, “determination interval 2”=“normal, abnormal, abnormal”, and “determination interval 3”=“normal, normal, abnormal”. In this case, by the analysis on the region (range) of the “determination interval 2”, p3 (reservation inquiry) and p5 (DB2) are narrowed as the problem points.

(Method of Classifying Mormal Interval and Abnormal Interval)

A sparse case where the normal interval and the abnormal interval exist in a sparse manner and a superimposed case where the normal interval and the abnormal interval exist in a superimposing manner may be considered.

(Sparse Case)

In the sparse case, classification by the following methods may be considered.

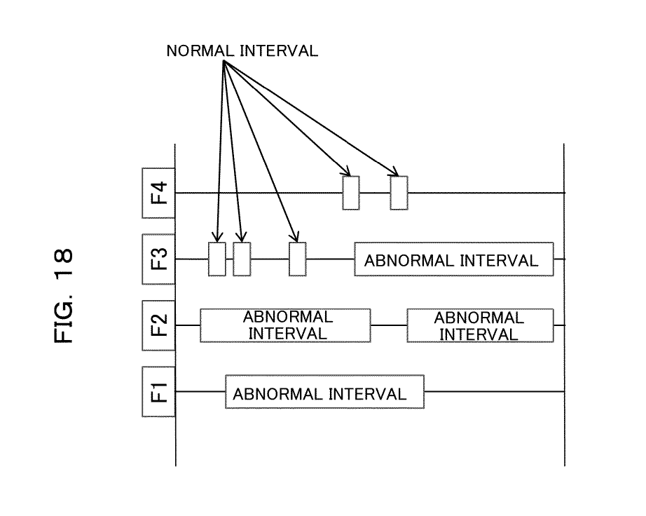

(Method 1) A request-response data (hereinafter, referred to as “RR data”) unit is set as the determination interval (see FIG. 18). In other words, interval of RR data=normal interval or abnormal interval. Note that, in FIG. 18, data of the normal interval or the abnormal interval indicated by a rectangle corresponds to RR data.

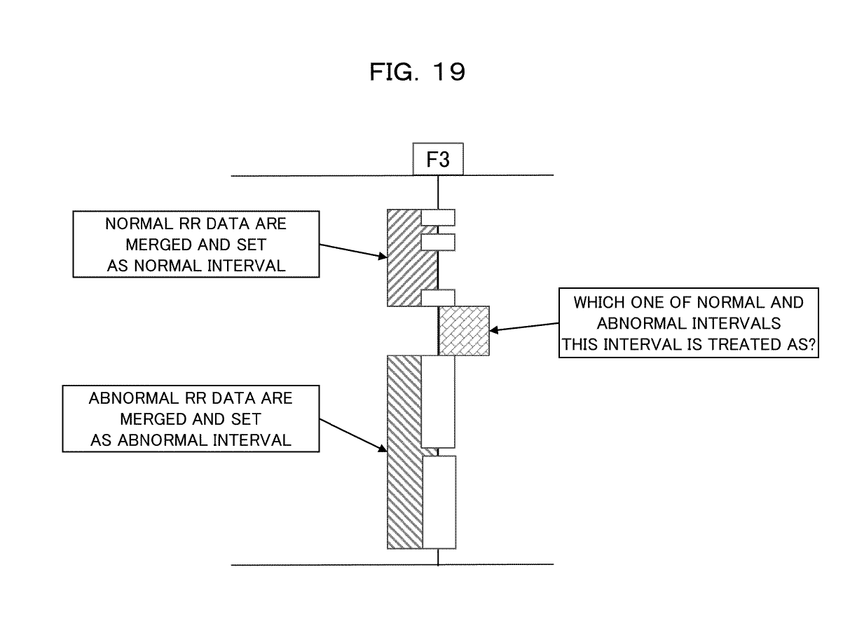

(Method 2) The normal RR data are merged and set as the normal interval, and the abnormal RR data are merged and set as the abnormal interval (see FIG. 19). As compared with the method 1, the number of the intervals can be suppressed, and thus, the processing time can be reduced. In FIG. 19, several methods of determining into which one the RR data non-existence interval of the switch of the normal interval and the abnormal interval is incorporated may also be considered (depending on the setting).

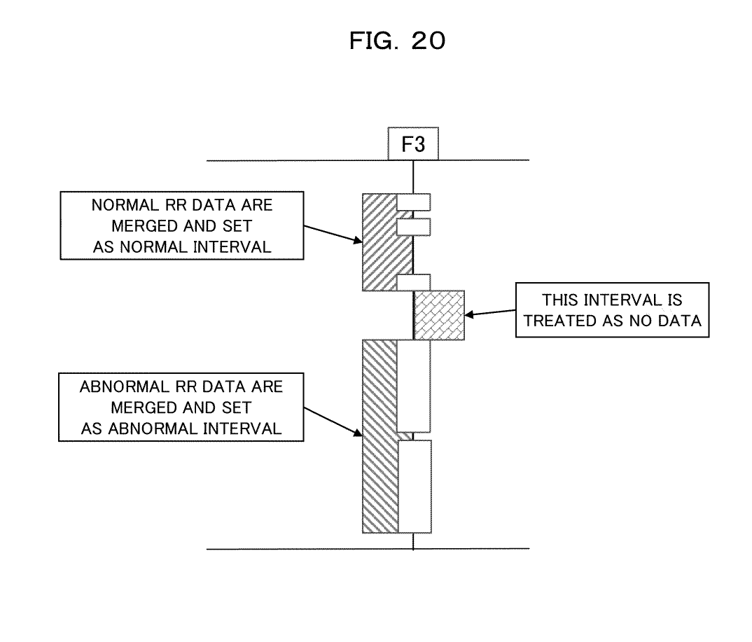

(Method 2-1) The RR data non-existence interval of the switch of the normal interval and the abnormal interval is neither normal nor abnormal and is treated as “no data” (see FIG. 20). The present method 2-1 is used when wanting to find the normal/abnormal intervals strictly.

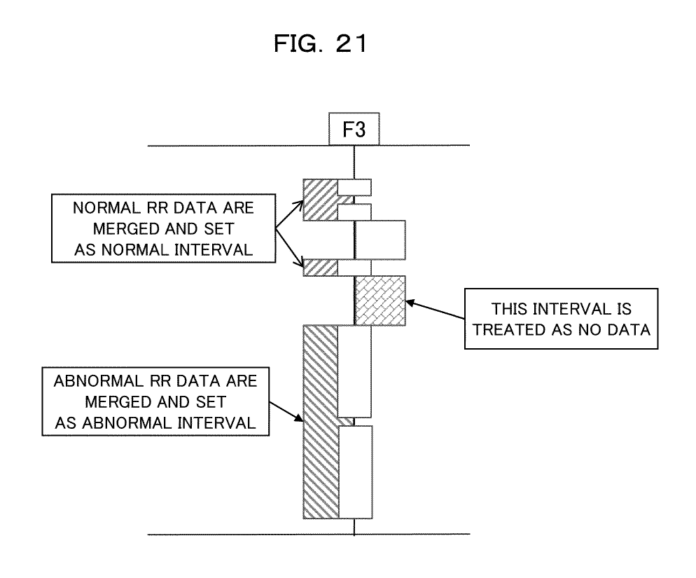

(Method 2-1′) Like the above method 2-1, the RR data non-existence interval exceeding the threshold values of the normal interval and the abnormal interval is treated as “no data” (see FIG. 21). The threshold value in the case of being treated as “no data” may use an average value of the normal /abnormal RR data, or may use a threshold time determining as normal/abnormal.

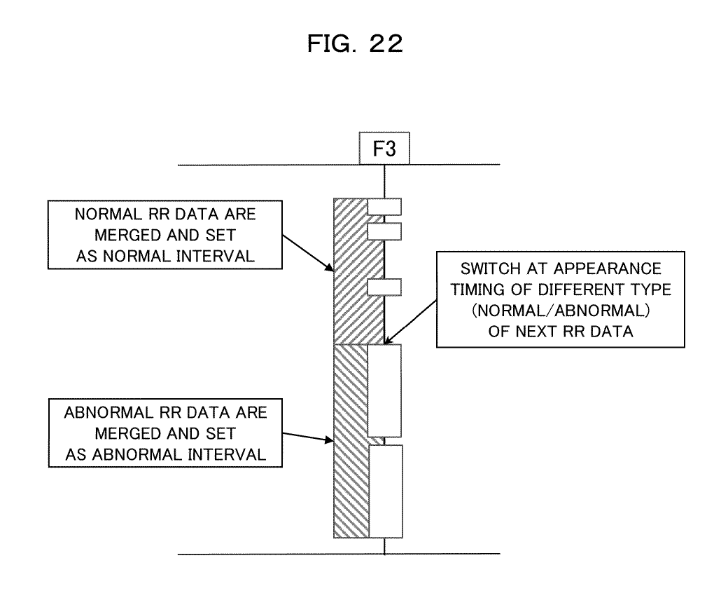

(Method 2-2) The interval may be switched at a timing where next RR data of the switch (different type (normal/abnormal)) of the normal interval and the abnormal interval appears (see FIG. 22).

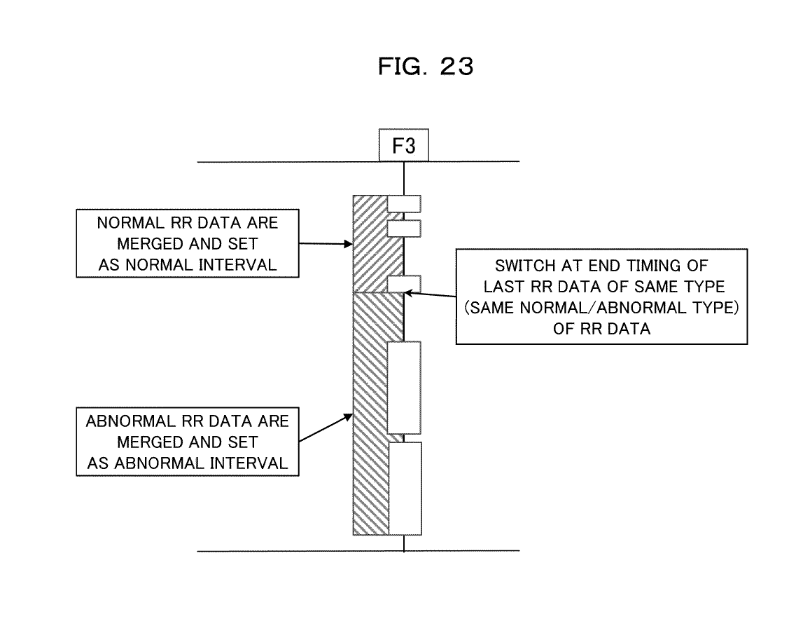

(Method 2-3) The interval is switched at an end timing of the last RR data of the same type (same normal/abnormal type) of RR data (see FIG. 23).

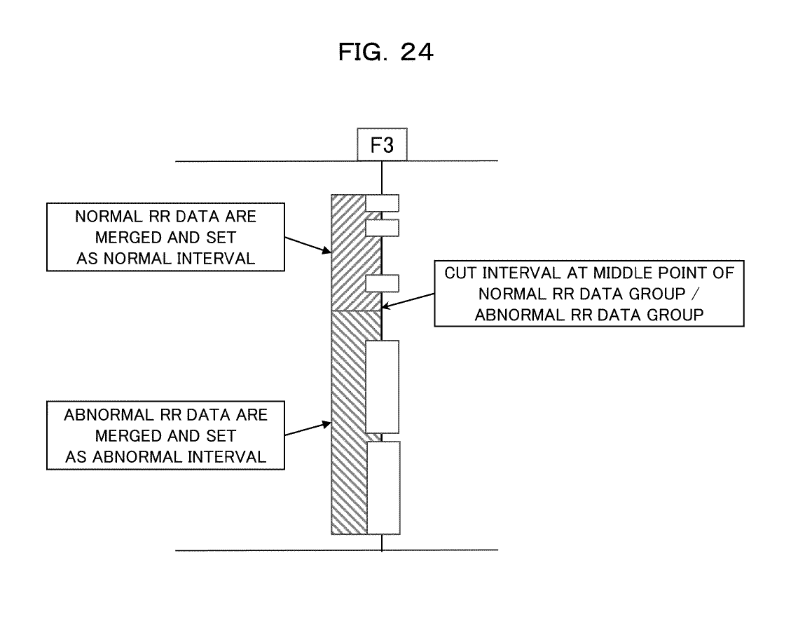

(Method 2-4) The interval is switched at a middle point of the normal RR data group and the abnormal RR data group (see FIG. 24). Note that, the middle point is a non-limiting example and may be a middle of the data non-existence interval or a point separated by an average value of the normal RR data.

Basically, the method 2-1 or the method 2-1′ is used, and a case where the RR data non-existence interval is long may be treated as “no data”. This is because a correct result is not obtained even when identification processing is performed using the matrix based on ambiguous information (even when data does not exist, it is treated as normal). However, in a case where RR data are too small and interval information necessary for analysis is incomplete, identification processing may be performed at the expense of accuracy, for example, by loosening the threshold value.

(Superimposed Case)

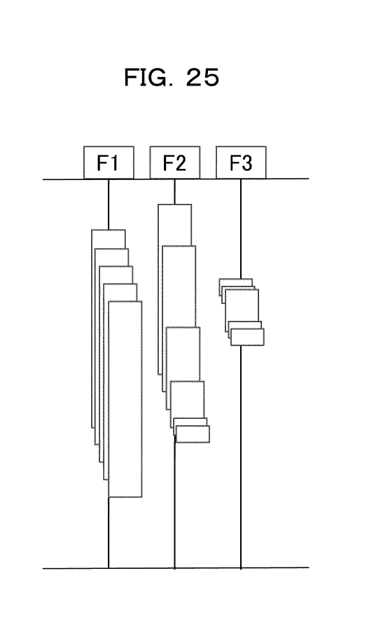

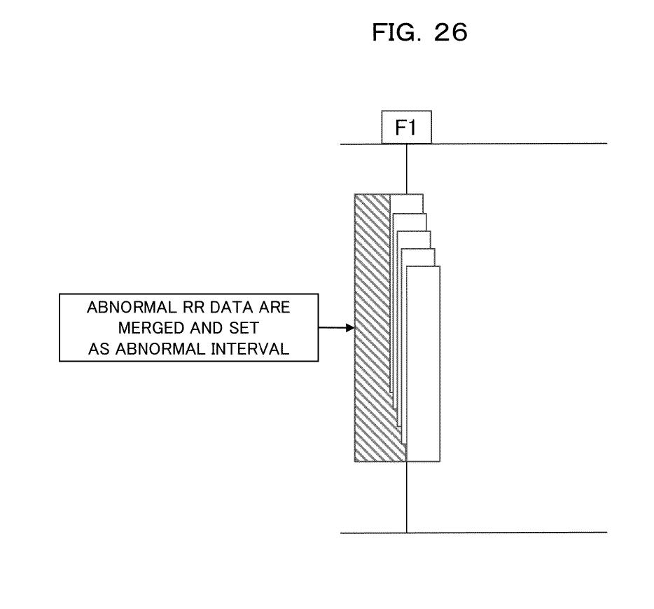

When the RR data are superimposed as illustrated in FIG. 25, the interval from the start to end of the same type of the RR data is basically set as one normal interval or abnormal interval as illustrated in FIG. 26.

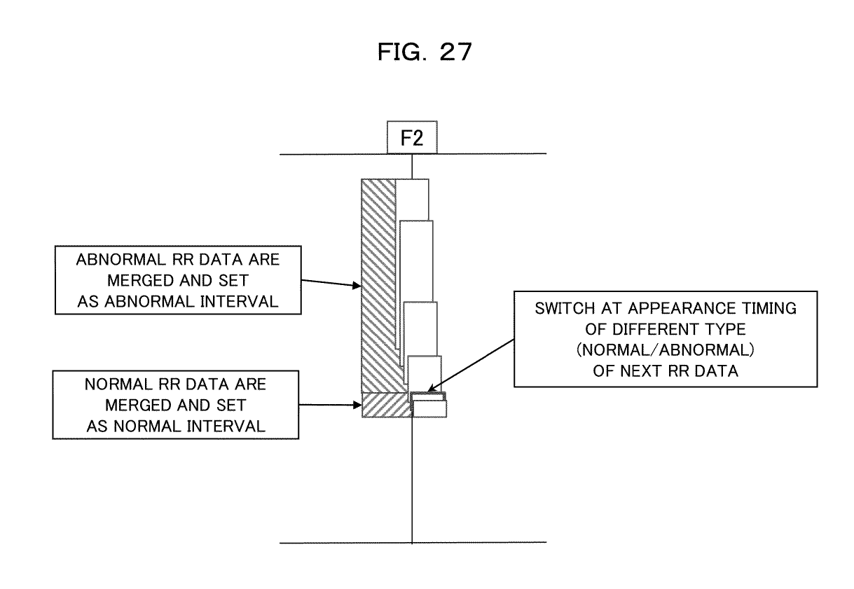

(Method 1) The interval is separated at a start timing (appearance timing) of different types (normal/abnormal) of next RR data (see FIG. 27). In typical cases, a delay is generated in one processing by a certain cause (for example, lock of a DB), and another processing is waited by the processing. Hence, likewise, a delay is also generated in another processing. The present method 1 is based on the assumption that when the cause of delay of the basic processing is solved, the other processings are immediately ended, and subsequent RR data are normal.

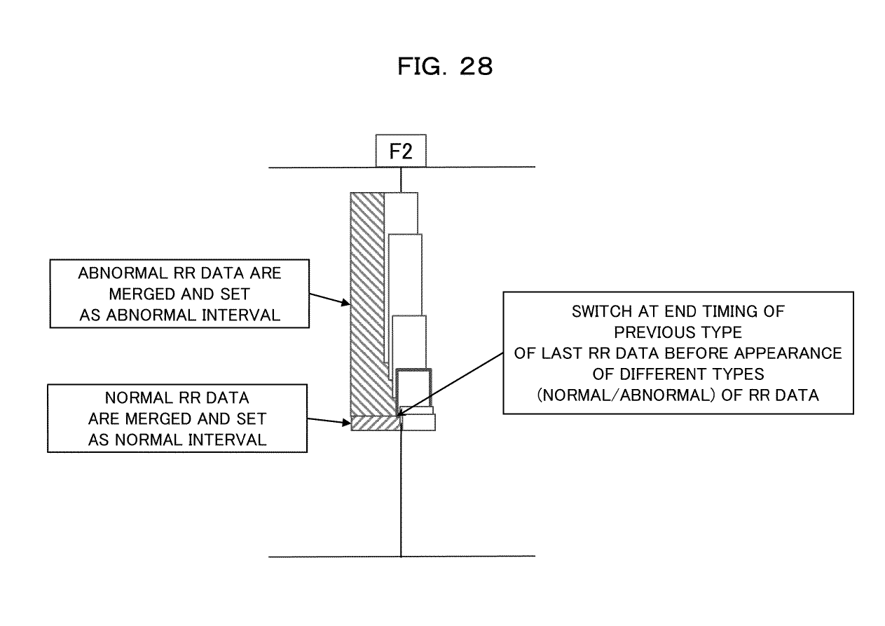

(Method 2) The interval is separated at an end timing of a previous type of the last RR data upon appearance of different types (normal/abnormal) of RR data (see FIG. 28).

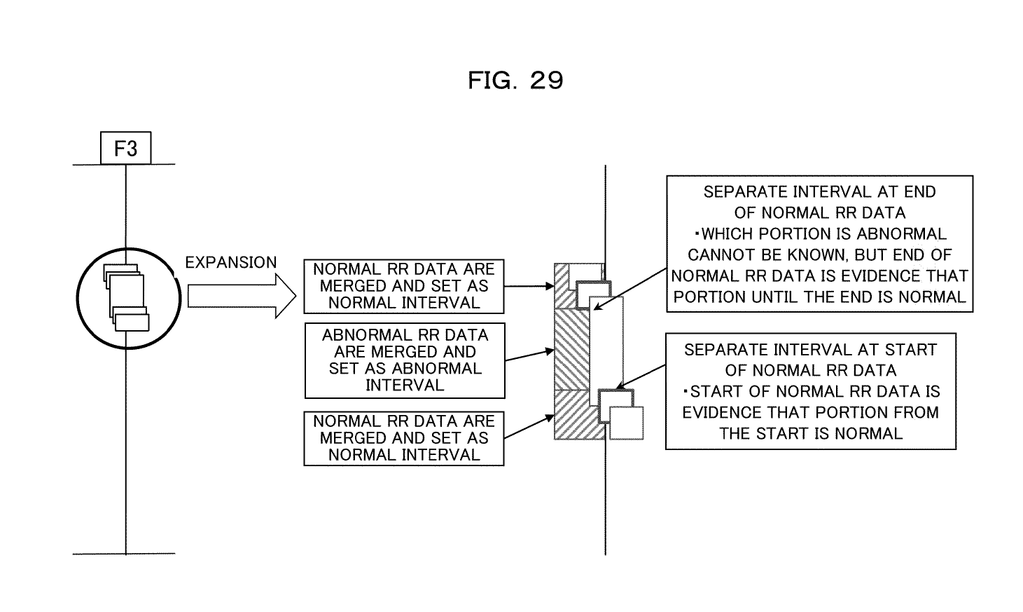

(Method 3) The interval is separated as the normal interval at the start of the normal RR data, and the interval is separated at the end of the normal RR data (see FIG. 29). Usually, the method 3 may be used. The reason for separating the interval at the end of the normal RR data is that which portion is abnormal cannot be known, but the end of the normal RR data is an evidence that a portion until the end is normal. The reason for separating the interval at the start of the normal RR data is that the start of the normal RR data is an evidence that a portion from the start is normal.

(Variation)

A timing covering components as many as possible may be found. This is because as more components appear, the narrowing degree is high. Also, a timing where functions (for example, URL type) are gathered as many as possible may be found. This is because as there are more patterns, the narrowing is easier.

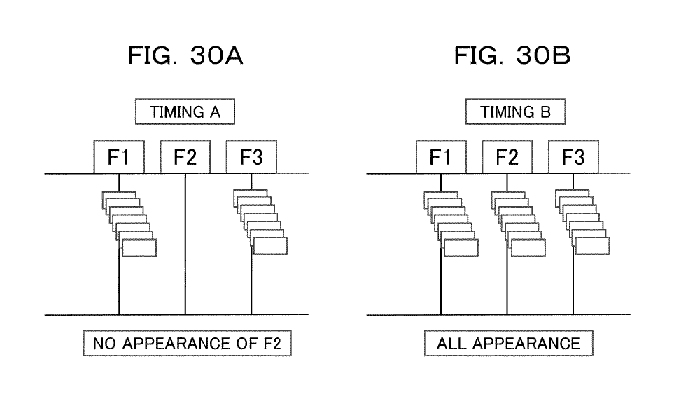

For example, at a timing A illustrated in FIG. 30A, the RR data of some function (F2) does not appear. However, at a timing B illustrated in FIG. 30B, the RR data of all functions (F1, F2, F3) appear. In this case, the RR data of the timing B instead of the timing A may be used for determination.

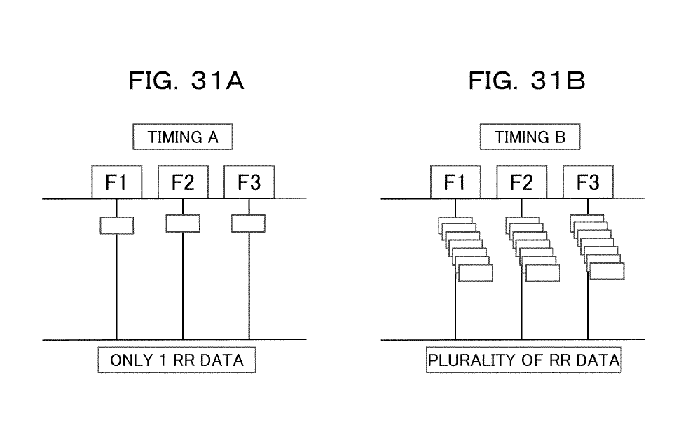

Further, it may wait until a plurality of RR data of the same function (for example, URL) appears. This is because just one may be a chance. For example, at the timing A illustrated in FIG. 31A, only one RR data of each function F1, F2 and F3 appears. However, at the timing B illustrated in FIG. 31B, a plurality of RR data of each function F1, F2 and F3 appears. In this case, the RR data of the timing B instead of the timing A may be used.

(Analysis Apparatus Notifying Point Having Conflict Probability)

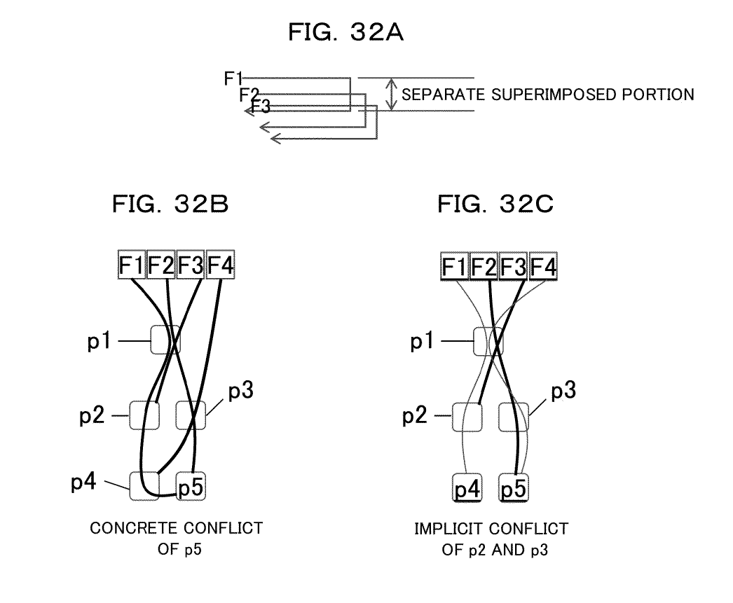

As schematically illustrated in FIG. 32A, the RR data temporally superimposed with the delay RR data is separated, and the problem point is narrowed in the separated range. This is based on the idea that the use of statistic values alone cannot detect the occurrence of instantaneous conflict.

(Detection of Concrete Conflict)

It is notified that the narrowing is actually possible as the problem point. FIG. 32B is an example in which p5 is a concrete conflict point.

(Detection of Implicit Conflict)

The point that does not appear as a common problem point but generates the same problem at a high probability if a problem occurs is notified as an implicit conflict (it should not conflict but it conflicts with something in the back). This corresponds to a combination of a short-term analysis and a long-term analysis in a certain sense. FIG. 32C illustrates an example in which p2 and p3 are the implicit conflict points.

(Notification of Conflict-Possible Point)

The point is notified as the conflict-possible point, including the concrete conflict and/or the implicit conflict. The accuracy may be ranked from the narrowing degree and the simultaneous generation probability.

(Accuracy is Improved by Supplement with Information Upon Analysis)

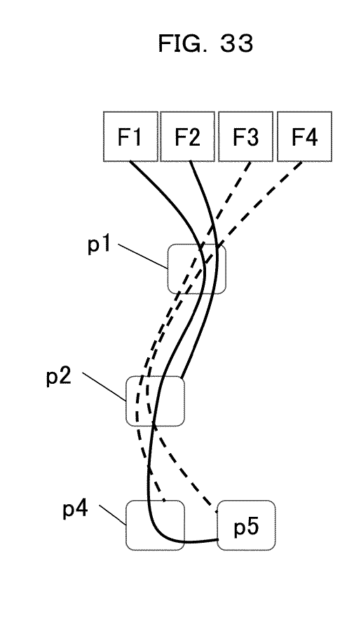

When the narrowing is impossible in the information of the analysis phase, a point that “the identification is possible if no problem (or deterioration) is proved by this checkpoint” is extracted. For example, in FIG. 33, when wanting to identify which one of p4 and p5 is the cause, a request passing through the point is input from the data used in the pre-analysis phase. It is more efficient if preparing for a supplementary table (index) that extracts a “candidate request” from the point.

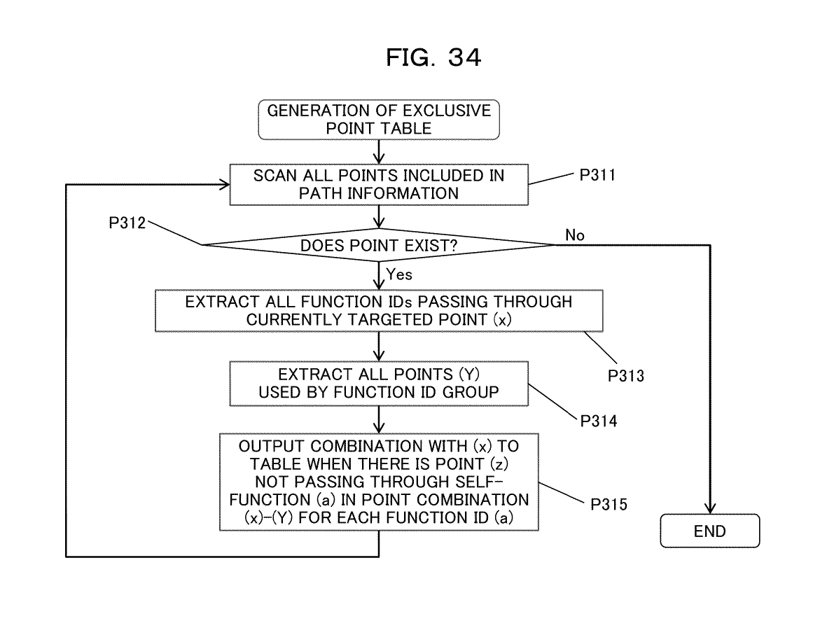

A flow of generating the supplementary table is illustrated in FIG. 34.

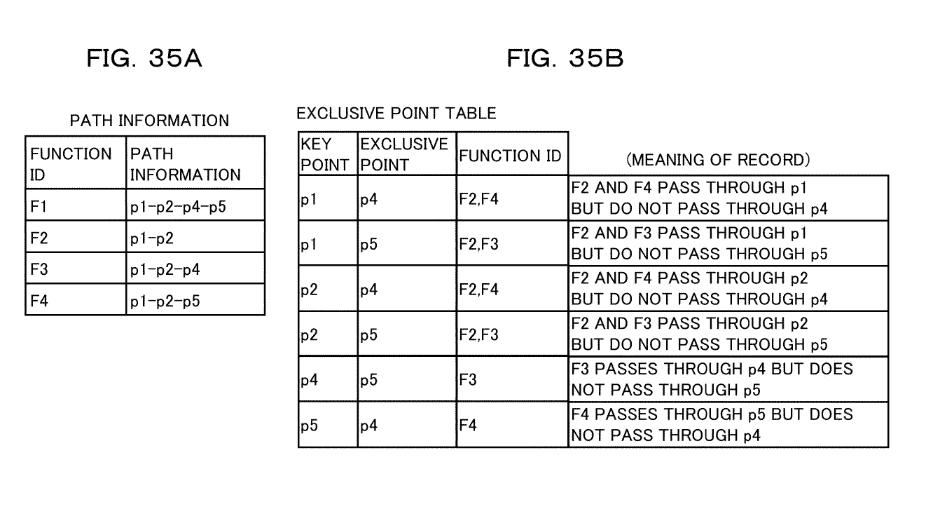

For example, the path analysis unit 420 (see FIG. 1) scans all points (p1, p2, p4, p5) included in the path information (see, for example, FIG. 35A) in the path information database 404 (processing P311), and checks whether a point exists (processing P312).

As the checking result, when the point exists (Yes in processing P312), the path analysis unit 420 extracts all function IDs passing through the currently targeted point (key point) (x) (processing P313). For example, in FIGS. 33 and 35A, when the key point is p4, the functions F1 and F3 pass, and thus, the functions F1 and F3 are extracted. Also, when the key point is p1, the functions F1, F2, F2, F3 and F4 pass, and thus, the functions F1, F2, F2, F3 and F4 are extracted.

Next, the path analysis unit 420 extracts all points (Y) used by the extracted function ID group (processing P314). For example, when the extracted functions are F1 and F3, p1, p2, p3, p4 and p5 are extracted. Also, when the extracted functions are F1, F2, F2, F3 and F4, p1, p2, p4 and p5 are extracted.

When there is a point (exclusive point) (z) not passing through self-function (a) in a point combination (x)-(Y) for each function ID (a), the path analysis unit 420 outputs a combination with (x) to the table (processing P315), and returns to processing P311.

For example, in the function F1, all pass through (Y)=p1, p2, p4 and p5. In the function F3, p5 does not pass through (Y)=p1, p2, p4 and p5. In this case, the path analysis unit 420 outputs the record of p4, p5 and F3 to the table. The corresponding record means that the function F3 passes through p4 but does not pass through p5 (see FIG. 35B).

Also, the function F1 passes through all points. The function F2 does not pass through the points p4 and p5. Therefore, the path analysis unit 420 outputs the record of (p1, p4, F2) and (p1, p5, F2) to the table. Also, since the function F3 does not pass through the point p5, the path analysis unit 420 outputs the record of p1, p5, (F2), and F3 to the table. Also, since the function F4 does not pass through the point p4, the path analysis unit 420 outputs the record of p1, p4, (F2), and F4 to the table.

In this manner, with respect to the path information illustrated in FIG. 35A, the supplementary table (exclusive point table) illustrated in FIG. 35B is generated. Note that, in processing P312, when the point does not exist (No route in processing P312), the path analysis unit 420 ends the processing.

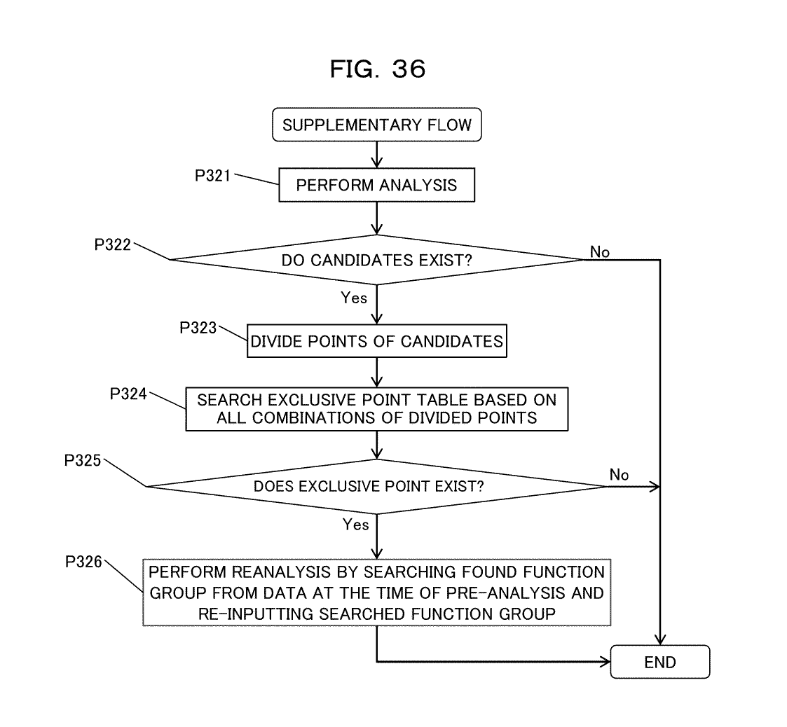

Note that, it is more efficient if preparing for a table (index) such that the “candidate request” can be extracted by narrowing. A flow of supplementing data when data is lacking is illustrated in FIG. 36.

The path analysis unit 420 performs analysis (processing P321), and checks whether a plurality of candidates exists (processing P322). For example, in the actual operation phase, p4 and p5 become delay candidates when data in which the function F1 is abnormal and the function F2 is normal exists and data regarding the functions F3 and F4 does not exist.

When the plurality of candidates exists (Yes in processing P322), the path analysis unit 420 divides points of the candidates (processing P323). For example, when the candidates are p4 and p5, the points of the candidates are divided into p4 and p5.

Next, the path analysis unit 420 searches the exclusive point table (see, for example, FIG. 35B) in all combinations of the divided points (processing P324). For example, the function F3 is found if searching the exclusive point table illustrated in FIG. 35B with a search key=p4 and an exclusive point key=p5. Also, the function F4 is found if searching the exclusive point table illustrated in FIG. 35B with a search key=p5 and an exclusive point key=p4.

The path analysis unit 420 checks whether the exclusive point exists (processing P325). When the exclusive point exists (Yes in processing P325), reanalysis is performed by searching a found function group from data of the pre-analysis phase and re-inputting the searched function group (processing P326). For example, data corresponding to the functions F3 and F4 found in processings P324 and P325 are re-input and analyzed.

By re-inputting the “candidate request”, the information of a deficient targeted check point can be supplemented, and the problem point can be narrowed (identified). For example, if there is no problem by re-inputting the request corresponding to the function F3, it may be determined (identified) that the cause of deterioration is p5.

Note that, when the narrowing (identification) cannot be performed, other “candidate request” may be used. For example, if the deterioration is caused by re-inputting the request corresponding to the function F4, it may be determined that p4 is suspected as the cause of deterioration. The reliability may be increased by re-inputting a plurality of requests.

(Accuracy Improvement 1 using Appearance Probability)

In order to improve the accuracy of the problem point identification, a method using an appearance probability (frequency) may be considered.

(Pre-Analysis Phase)

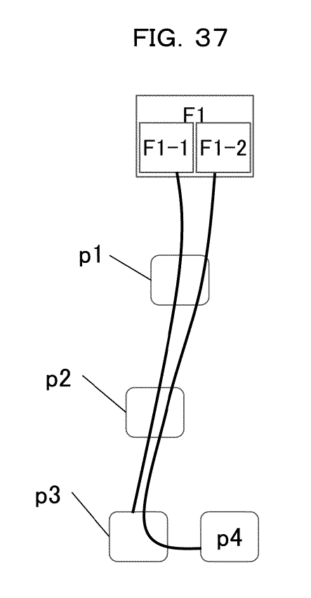

For example, as illustrated in FIG. 37, when passing through two types of paths, F1=p1-p2-p3 and F1=p1-p2-p3-p4, it is impossible to identify which one of the two paths the function F1 passes through, from external information such as parameter of F1.

Herein, the path of p1-p2-p3 is set as F1-1, and the path of p1-p2-p3-p4 is set as F1-2. The parameter of F1 alone cannot classify which one of F1-1 and F1-2 the function F1 passes through, but can identify which path the function F1 passes through in the pre-analysis phase. Thus, the path analysis unit 420 counts each frequency. As a result, the appearance probability of F1, for example, may be prepared as follows: F1-1 is 70% and F1-2 is 30%.

(Actual Operation Phase)

The information of the actual operation phase alone can know that the function is F1 by the parameter, but cannot identify whether the path is the F1-1 path or the F1-2 path. In a case where F1 has good response at a probability of 70% and has bad response at a probability of 30%, it may be estimated by the problem point identifying unit 460 that the point of p4, which is a difference between F1-1 and F1-2, is the cause of deterioration.

(Flow Using Appearance Probability)

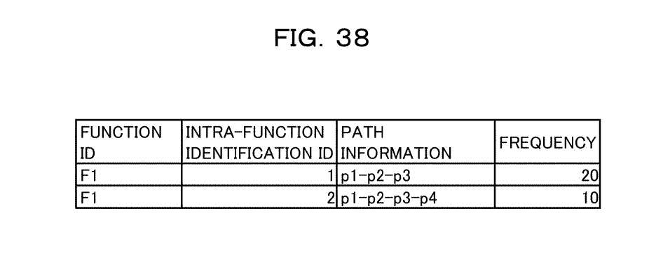

In processing P60 of the flow in the pre-analysis phase illustrated in FIG. 4, the path analysis unit 420, for example, registers the frequency information (table) in the appearance probability information database 405 as illustrated in FIG. 38.

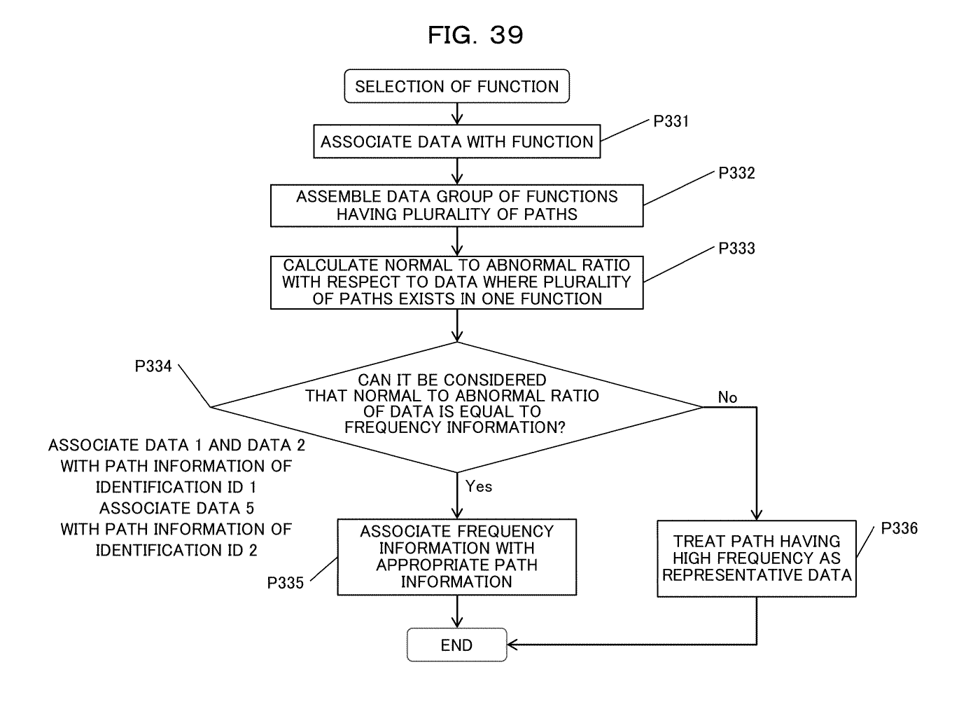

As illustrated in FIG. 39, the path analysis unit 420 associates the data with the function (processing P331).

For example, the data and the function are associated as follows: “data 1:F1=◯”, “data 2:F1=◯”, “data 3:F2=◯”, “data 4:F3=×”, and “data 5:F1=×”.

Next, the path analysis unit 420 assembles a data group of functions having a plurality of paths (processing P332). For example, it can be known from the frequency information table illustrated in FIG. 38 that the function F1 has a plurality of path information. Thus, three data groups, “data 1:F1=◯”, “data 2:F1=◯”, and “data 5:F1=×”, are assembled.

Further, the path analysis unit 420 calculates a normal to abnormal ratio with respect to data where a plurality of paths exists in one function (processing P333). In the case of the above-described example, 66.7% is normal and 33.3% is abnormal.

The path analysis unit 420 checks whether it can be considered that the normal to abnormal ratio of data is equal to the frequency information (processing P334). In the case of the above-described example, since 66.7% is normal and 33.3% is abnormal, it can be considered as equal to each other. When considered as equal to each other (Yes in processing P334), the path analysis unit 420 associates the frequency information with appropriate path information (processing P335). On the other hand, when not considered as equal to each other (No in processing P334), the path analysis unit 420 treats a high-frequency path as representative data (processing P336).

(Accuracy Improvement 2 Using Appearance Probability)

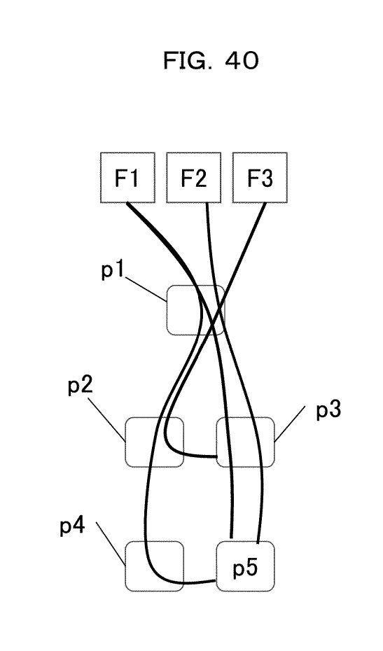

As illustrated in FIG. 40, the path of the function F1 has two types, that is, F1(F1-1)=p1-p2-p4-p5 and F1(F1-2)=p1-p3-p5, the path of the function F2 is F2=p1-p3-p5, and the path of the function F3 is F3=p1-p2-p3. In this case, a plurality of paths that cannot be classified by the parameter or the like exists in the function F1.

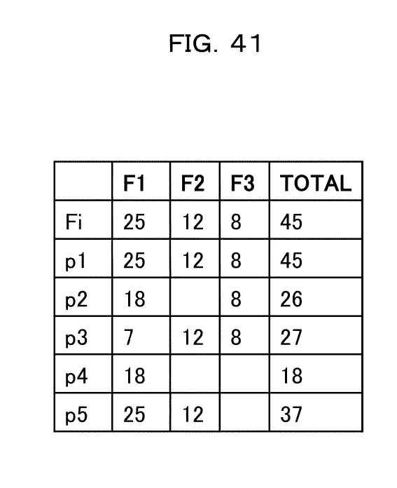

The pre-data collection unit 410 reproduces the request data stored in the user request database 403, and the path analysis unit 420 counts a frequency of the request data passing through each function as illustrated in FIG. 41 (counts a frequency at each Fi and pi).

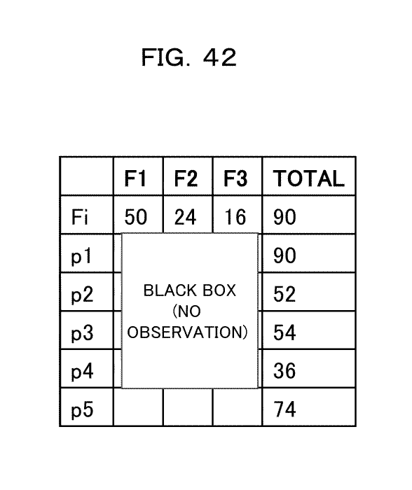

In the actual operation phase, the function selection unit 440 counts the appearance frequency of each check point (pi) (see FIG. 42). However, details information regarding the function Fi is not checked because the log collection amount or the throughput by the association processing increases.

In FIG. 20, it is assumed that F1 and F2 are deteriorated and F3 is normal. In this case, the possibility of cause of deterioration remains in p4 and p5. Among all requests during the aggregation interval of the function F1 of the actual operation phase, for example, the request of 28% (=14/50) is assumed as deteriorated. In this case, as compared with the frequency information table illustrated in FIG. 41, the path of F1-2 (p1-p3-p5) is estimated as deteriorated. Hence, it can be seen that p4 (F1-1) is not deteriorated. As a result, p5 can be determined as the cause point.

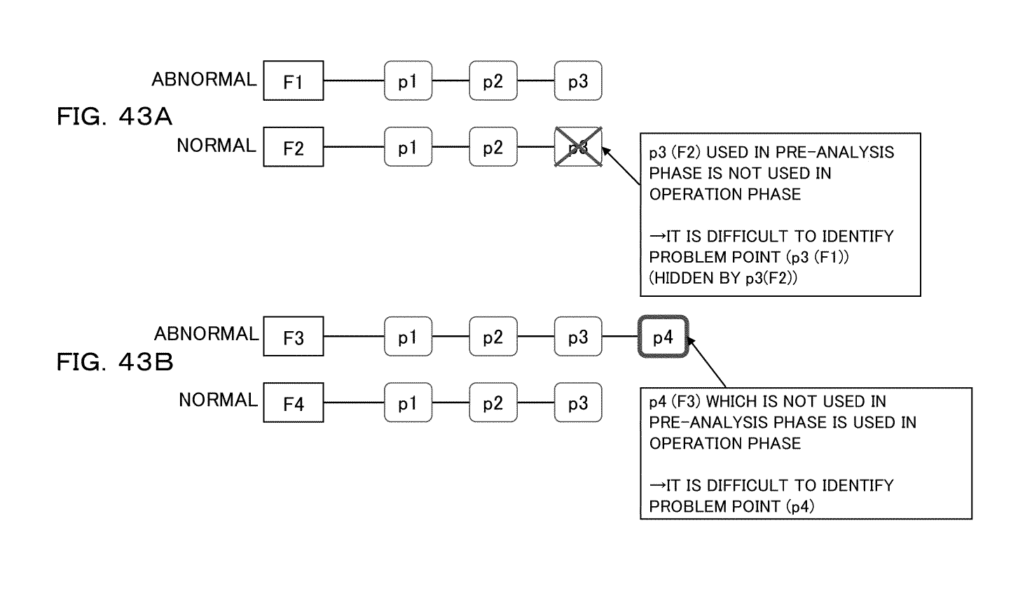

In connection with the processings P150 to P190 in FIG. 5 (processings P227 to P230 in FIG. 17), an inexpedience when path information generated in the pre-analysis phase is different from (inconsistent with) execution content of processings in the operation phase will be described with reference to FIGS. 43A and 43B.

There is a case in which a component which is different from a component used in the pre-analysis phase are used in the operation phase. In this case, the problem point identifying unit 460 has a difficult to identify the problem point.

As an example, as illustrated in FIGS. 43A and 43B, in a case where all of the functions F1 to F4 pass through the components p1, p2, and p3 in the pre-analysis phase, p1, p2 and p3 are associated with any of F1 to F4 in the path information. In this case, it is considered that F1=abnormal, F2=normal, F3=abnormal, and F4=normal.

FIG. 43A illustrates a case where in the operation phase, in F2, p3 of p1, p2, and p3 used in the pre-analysis phase (which F2 passes through) is not used, and p3 is also a problem point. In this case, in the path information, p3 (in F1) which is the problem point is hidden by p3 in F2 because p3 is included in a path of F2 according to the path information. To this end, the problem point identifying unit 460 has difficulty to identify p3 of Fl as a problem point.

In addition, FIG. 43B illustrates a case where in the operation phase, in F3, in addition to p1, p2, and p3, p4 which has not been used in the pre-analysis phase (through which F3 have not passed) is used and p4 is a problem point. At this time, since, in the path information, p4 is not included in a path of F3, the problem point identifying unit 460 has a difficulty to identify p4 of F3 as a problem point.

As a case where a situation as illustrated in FIGS.

43A and 43B occurs, there is a case where processing content in a function Fi is branched by an internal state (a time point, a value obtained from DB, or the like) or a parameter which is hard to identify from externally or the like. In this case, if the condition branch of the function Fi has not been covered in the pre-analysis phase, in the function Fi, different components may be used in a pre-analysis phase and an operation phase. Even in any pattern of FIGS. 43A and 43B, normal and abnormal function is not respectively limited to one function and the above pattern can be configured by a combination of a plurality of functions.

In the present embodiment, a case where it is impossible to find out a component pj (j is natural number) which becomes a problem point from an abnormal function Fi is grasped as an “inconsistency state” between the path information and a system state (a path of the function Fi in the case of being recorded in the log information). The inconsistent state may refer to a state in which a component of a normal function hides a component of the abnormal function Fi.

(Processing in Case of Detecting Inconsistent State)

Processing in a case where a problem point is not identified and an inconsistent state is detected in processing P160 of FIG. 5 by the problem point identifying unit 460 will be described below.

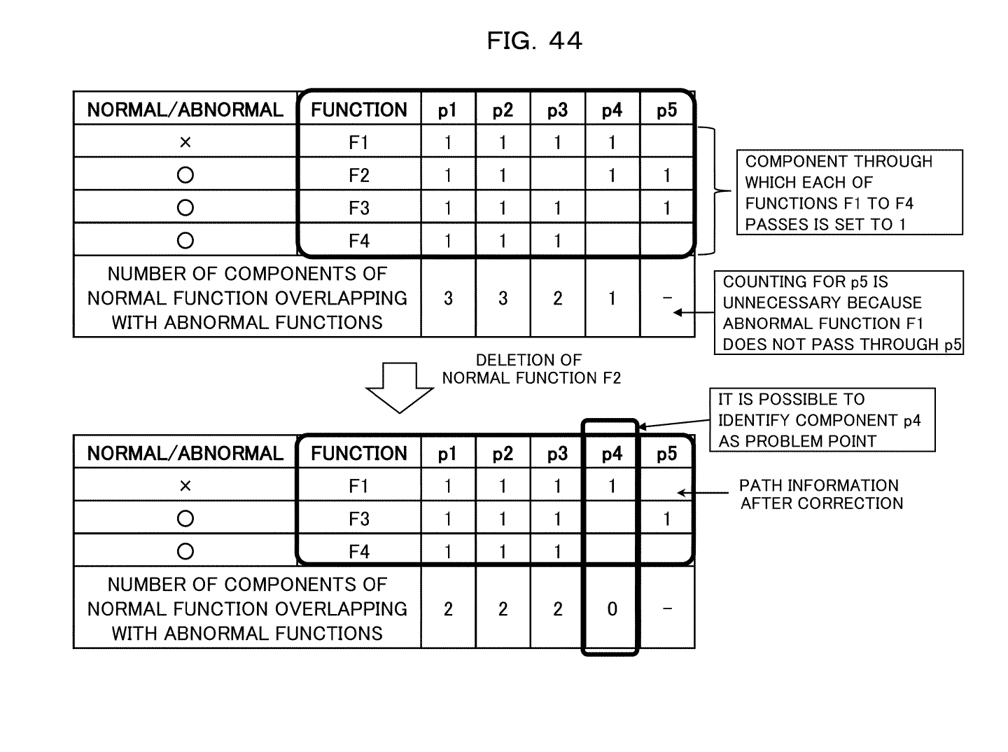

As an example of a general processing, when detecting the inconsistent state in identification of a problem point (processings P150 and P160 in FIG. 5), the problem point identifying unit 460 performs correction of the path information (see FIGS. 44 to 47). The problem point identifying unit 460 re-performs processing of identifying a problem point, making it possible to identify the problem point from the inconsistent state.

In the upper sides of FIGS. 44 to 47, there are tables indicating combinations of path information representing correspondence relation between functions and components, and an abnormal or normal state at a certain timing (slice) of each function obtained from log information of each function performed during a predetermined time interval. In the tables, with respect to each component used by a delay function, the number of normal functions which use the component is set. In the lower sides of FIGS. 44 to 47, the path information after correction by the problem point identifying unit 460 is illustrated.

As correction methods of the path information, there are the following methods.

(Method I) At least one function is deleted based on a predetermined condition from a plurality of functions including normal functions and abnormal functions.

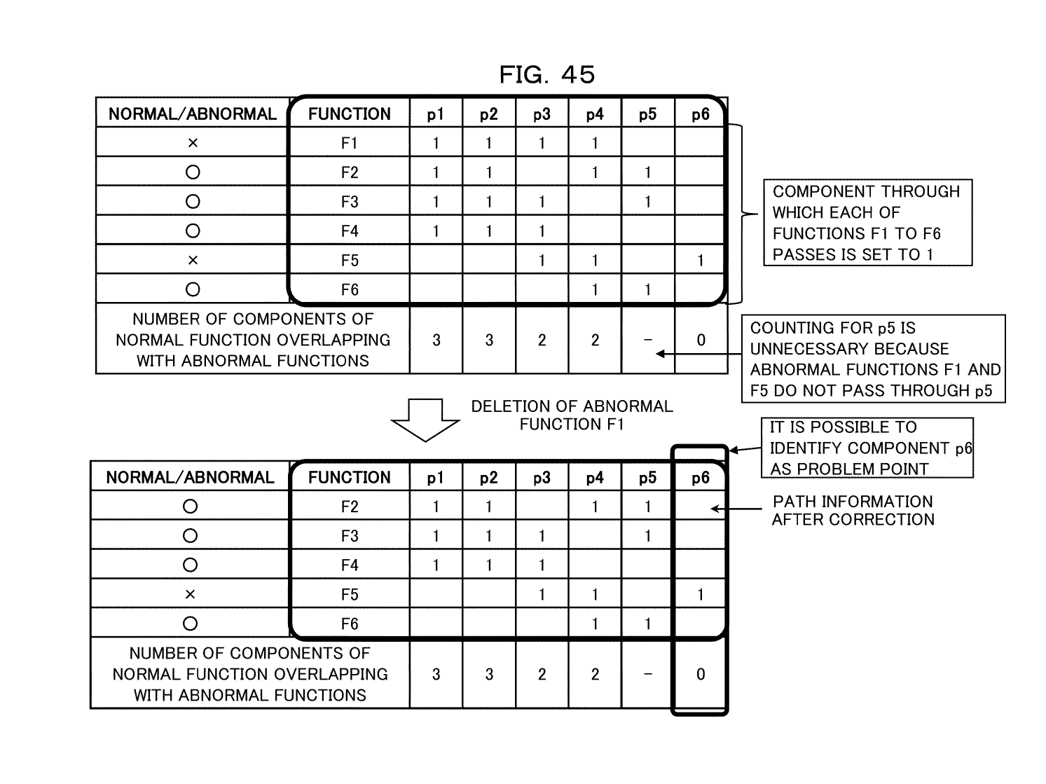

In this method, as illustrated in FIGS. 44 and 45, according to the path information and a normal or abnormal state of each function, at least one of the normal function and the abnormal function is deleted.

(Method I-1) In the example of FIG. 44, as illustrated in the upper side, combinations of normal functions F2 to F4 all hide components (p1, p2, p3, and p4) used by an abnormal function F1, that is, abnormal component candidates. In this case, the problem point identifying unit 460 deletes all normal functions (in this case, F2) which use a component (in this case, p4) having the smallest reliability from the normal functions F2 to F4 having a component, which hide the components used by the abnormal function F1, in the path information.

The reliability is an example of an evaluation value indicating a possibility that a normal function passes through an abnormal module candidate. In the example of FIG. 44 (and FIGS. 45 to 47), the number of components of a normal function overlapping with an abnormal function is used as reliability.

As illustrated in the lower side of FIG. 44, since the normal function F2 has been deleted in the path information after deletion, the problem point identifying unit 460 can identify p4 as the problem point.

In addition, an example in the upper side of FIG. 44 is estimated as being a pattern in which F2 uses p4 in the pre-analysis phase, but F2 does not use p4 in the operation phase (pattern of FIG. 43A), from an identified result.

(Method I-2) In the example of FIG. 45, as illustrated in the upper side, p6 can be identified as a problem point in an abnormal function F5. On the other hand, combinations of normal functions F2 to F6 hide components (p1, p2, p3, and p4) used by an abnormal function F1 in F1. In this case, the problem point identifying unit 460 deletes the abnormal function F1 in which a problem point is not identified in the path information. Therefore, an inconsistent state can be resolved without effect on a result (p6 of the abnormal function F5 already identified as a problem point).

As illustrated in the lower side of FIG. 45, since in the path information after deletion, the abnormal function F1 has been deleted, the problem point identifying unit 460 can identify p6 as the problem point of abnormal function F5.

In addition, an example in the upper side of FIG. 45 is estimated as being a pattern in which F1 uses p6 in the pre-analysis phase, but F1 does not use p6 in the operation phase (pattern of FIG. 43B), from an identified result.

Although the examples in which a problem point is identified through the aforementioned (Method I-1) and (Method I-2) has been illustrated in FIGS. 44 and 45, the problem point identifying unit 460 can identify the problem point even by any of (Method I-1) and (Method I-2) when the inconsistent state is detected.

For example, in the upper side of FIG. 45, among the normal functions F2 to F6 having a component, which hide the components (p1, p2, p3, and p4) used by the abnormal function F1, all normal functions using a component having the smallest reliability (in this case, p3 or p4) may be deleted.

As an example, the problem point identifying unit 460 may delete all normal functions (in this case, F3 and F4) using p3 and identify p3 as a problem point in the abnormal function F1. Based on the identified result, a pattern (pattern of FIG. 43A) is estimated in which the functions F3 and F4 use p3 in the pre-analysis phase but do not use p3 in the operation phase.

Alternatively, the problem point identifying unit 460 may delete all normal functions (in this case, F2 and F6) using p4 and identify p4 as a problem point in the abnormal function F1. In this case, a pattern (pattern of FIG. 43A) is estimated in which the functions F2 and F6 use P4 in the pre-analysis phase but do not use p4 in the operation phase.

When the inconsistent state is detected, the problem point identifying unit 460 can determine which method is used among (I-1) and (I-2) of Method (I), and (II-1) and (II-2) of Method (II), through the below-described method. Alternatively, the problem point identifying unit 460 may select an optimal result (the number of components which are narrowed, for example) from results identified by using such two or more methods.

Although at least one function is described as being deleted from a plurality of functions in (Method I), all components (all components in the record of path information) using the function may be deleted instead of deleting all functions (record of path information).

(Method II) At least one component is changed based on a predetermined condition, from a plurality of functions including normal functions and abnormal functions.

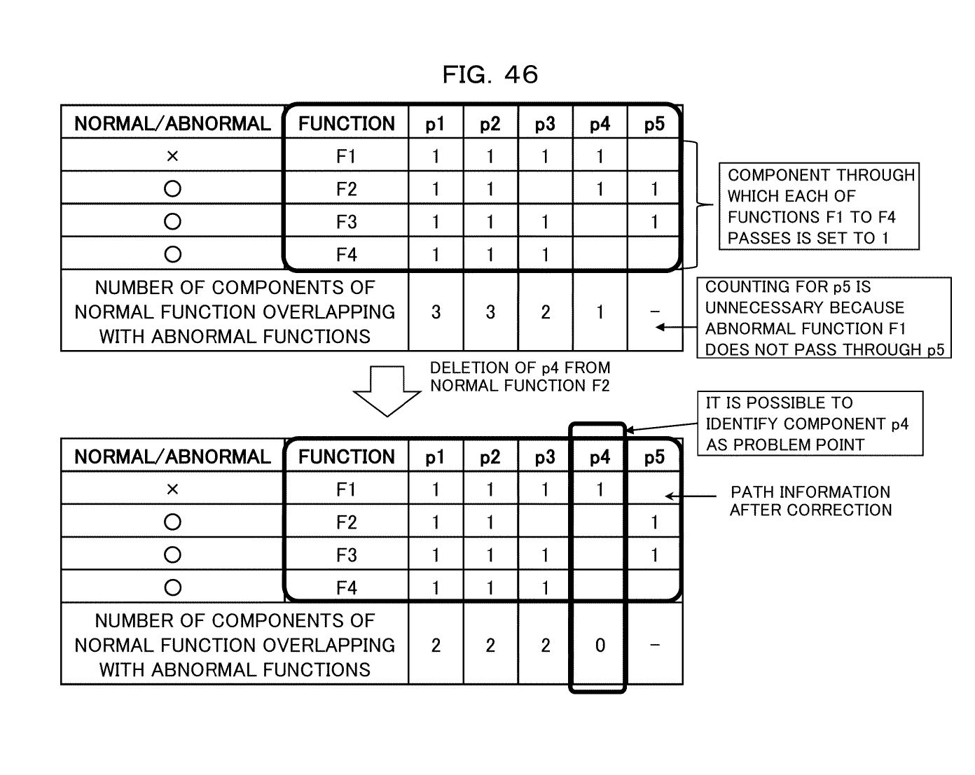

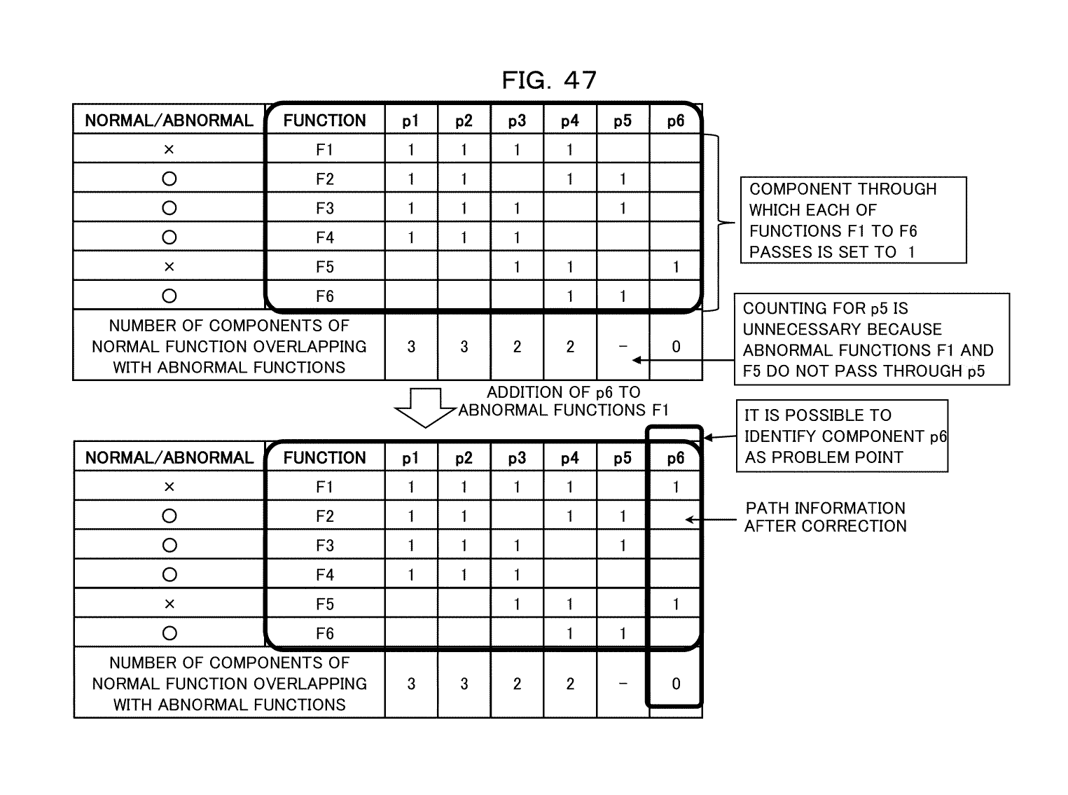

In this method, as illustrated in FIGS. 46 and 47, based on the path information and a normal and abnormal state of each function, deletion of at least one component or addition of at least one component are performed with respect to normal functions or abnormal functions. In the upper side of FIGS. 46 and 47, a situation similar to the upper sides of FIGS. 44 and 45 is assumed.

(Method II-1) As illustrated in the upper side of FIG. 46, the problem point identifying unit 460 deletes a component having the smallest reliability (in this case, p4) from the normal functions F2 to F4 having a component, which hide a component used by the abnormal function F1, in the path information.

As illustrated in the lower side of FIG. 46, since p4 is deleted from the normal function F2 in the path information after deletion, the problem point identifying unit 460 can identify p4 as a problem point. Therefore, it is possible to improve analysis precision since correction of the path information is minimized and the normal function F2 can be also used in narrowing of a problem point.

In addition, in a case where at this timing (slice), another function (for example, F5) in which a request does not occur exists in the path information and the function F5 uses p4, since F5 is not related with an inconsistent state, p4 is not deleted.

(Method II-2) As illustrated in the upper side of FIG. 47, the combinations of the normal functions F2 to F6 all hide components (p1, p2, p3, and p4) used by an abnormal function F1 in F1. In such a case, a component p6 is added to the abnormal function F1 in which a problem point is not identified. Therefore, an inconsistent state can be resolved without effect on a result (p6 of the abnormal function F5 already identified as a problem point).

As illustrated in the lower side of FIG. 47, since in the path information after deletion, a path of Fl is p1-p2-p3-p4-p6, the problem point identifying unit 460 can identify p6 as a problem point, which is common to the abnormal functions F1 and F5.

Even in FIGS. 46 and 47, when an inconsistent state is detected, the problem point identifying unit 460 can identify a problem point by any method of (Method II-1) and (Method II-2).

For example, in the upper side of FIG. 47, among the normal functions F2 to F6 having a component, which hide the components (p1, p2, p3, and p4) used by the abnormal function F1, a component having the smallest reliability (in this case, p3 or p4) may be deleted.

As an example, the problem point identifying unit 460 may delete p3 from all normal functions (in this case, F3 and F4) using p3 and identify p3 as a problem point in the abnormal function F1. Based on the identified result, a pattern (pattern of FIG. 43A) is estimated in which the functions F3 and F4 use P3 in the pre-analysis phase but do not use p3 in the operation phase.

Alternatively, the problem point identifying unit 460 may delete p4 from all normal functions (in this case, F2 and F6) using p4 and identify p4 as a problem point in the abnormal function F1. In this case, a pattern (pattern of FIG. 43A) is estimated in which the functions F2 and F6 use P4 in the pre-analysis phase but do not use p4 in the operation phase.

As in the example of FIG. 47, in a case where an inconsistent state can be resolved through addition or deletion of a component, the problem point identifying unit 460 may select any of the addition and the deletion based on a predetermined reference. At this time, the problem point identifying unit 460 gives top priority to, for example, deletion of a component having a low reliability and when an inconsistent state can be resolved through deletion of a component having a (sufficiently) low reliability, delete the component.

In addition, when a reliability of a deletion candidate component is not sufficiently low than a reliability of another component, the problem point identifying unit 460 may give top priority to addition of a component. “Reliability is sufficiently low” refers to, for example, a case where, with respect to a deletion target component, the number of components of a normal function is smaller than 1 and a reliability thereof is equal to or smaller than ½ of a reliability of another component. In the example of FIG. 47, since reliabilities of p3 and p4 (in this case, the number of components of a normal function=2) is not equal to or smaller than 1 and larger than 1.5 that is ½ of a reliability of another component (p1 and p2=3), the reliabilities of p3 and p4 are not sufficiently low. In this case, the problem point identifying unit 460 may give top priority to addition of p6.

In addition, in operation after identification of a problem point in which correction of the path information is performed by the aforementioned method, the problem point identifying unit 460 may perform analysis by using at least one of corrected path information and non-corrected path information and output an analysis result. For example, the problem point identifying unit 460 may use at least one of the corrected path information (F1, F3, and F4) and the non-corrected path information (F1 to F4) in operation after correction of the path information in the example of FIG. 44. In addition, the problem point identifying unit 460 may use at least one of the corrected path information (F1, F2 (p4 is deleted), F3, and F4) and the non-corrected path information (F1 to F4) in processing P150 of FIG. 5 in operation after correction of the path information in the example of FIG. 46.

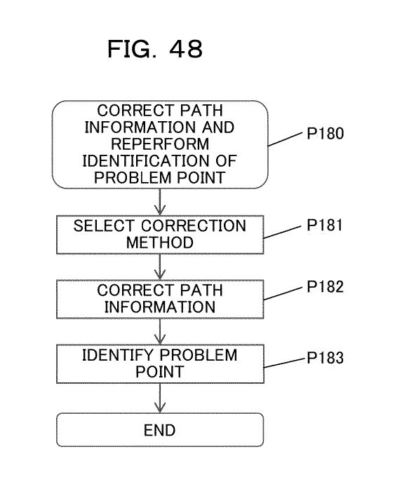

Next, an example of processing in the case of detecting the inconsistent state in the operation phase will be described with reference to FIGS. 48 to 55.

In the following description, it is assumed that the following information is generated by the pre-analysis block 401.

Example of Path Information (Reference Information)
F1, p1:p2:p3:p4, //foo.com/?tab=
F2, p1:p2:p4:p5, //foo.com/?col=5
F3, p1:p2:p3:p5, //foo.com/?col=4
F4, p1:p2:p3, //foo.com/?ui
(“http:”s are omitted from the above URLs)

Example of Component Defining Information

com/foo/pkg/servlet, p1, Servlet
com/foo/pkg/kernel, p2, Kernel
com/foo/pkg/log, p3, Log
org/hibernate/Session, p4, Hibernate
...

Example of Parameter Ttable

use, col
delvalue, tab
delvalue, ui
. . .

Example of Delay Determination Threshold Value
F1=1200 ms
F2=1800 ms
default=1500 ms

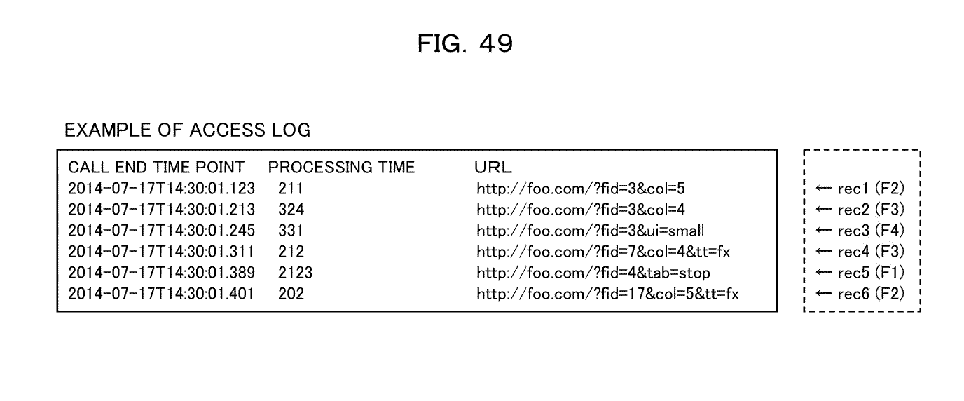

In addition, the parameter table is information representing handling of parameters included in a URL of an access log in function selection. In a case where the access log illustrated in FIG. 49 is collected, for example, “use, col” represents that a parameter of “col=5” in the URL is used as it is, and “delvalue, tab” represents that a value of a parameter of “tab=stop” in the URL is deleted and “tab=” is used. The operation block 402 can associate each record of the log illustrated in FIG. 49 with a function of the path information through the parameter table.

In the example illustrated in FIG. 49, processing times at input timings of rec1 to rec4 are compared to a delay determination threshold value and are determined as being normal values. However, a processing time of rec5 (F1) is 2123 ms which is higher than a threshold value 1200 ms of F1, and therefore, the operation block 402 detects a delay (state change).

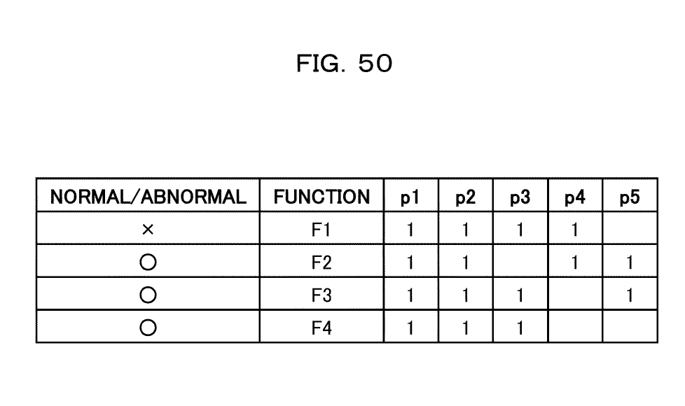

When information on the access log illustrated in FIG. 49 is reflected to the path information, it can be known that it is a state illustrated in FIG. 50. FIG. 50 illustrates a state similar to the upper side of FIG. 44. The problem point identifying unit 460 detects a state in which a problem point is hard to identify, that is, an inconsistent state in the state of FIG. 50.

As described above, when it is impossible to identify a problem point in processing P160 of FIG. 5 (No route of processing P160), the problem point identifying unit 460 reperforms correction of the path information and identification of a problem point (processing P180). At this time, the problem point identifying unit 460 performs processings in the processing P180, making it possible to identify a problem point (cause component).

First, as illustrated in FIG. 48, the problem point identifying unit 460 selects a correction method for the path information from both the aforementioned (Method I) and (Method II) (processing S181). A selection method compares the number of functions included in, for example, the path information, with the number of components. The selection method may select the (Method I) when the number of functions is larger than the number of components, and select the (Method II) when the number of components is larger than the number of functions. In the example of FIG. 50, since the number of functions (F1 to F4)=4 and the number of components (p1 to p5)=5, the problem point identifying unit 460 selects the (Method II).

As another example, when the number of components is larger than a specific value (for example, 10), (Method II) may be selected, and when the number of components is equal to or smaller than the specific value, (Method I) may be selected.

Alternatively, for example, when the number of functions is larger than a specific value (for example, 20), (Method I) may be selected, and when the number of functions is equal to or smaller than the specific value and the number of components is larger than a specific value (for example, 30) or the number of functions×a specific number (for example, 1.5) (Method II) may be selected. In this case, if the condition is not satisfied, it may be possible to select (Method I).

Such a condition may be arbitrarily set by an administrator of the analysis apparatus. In addition, a certain correction method for the path information may be fixedly used, without selecting the correction method according to a condition as described above.

In addition, the problem point identifying unit 460 may perform correction of the path information and analysis of a problem point by using the certain correction method, and then perform re-analysis by using another correction method depending on an analysis result. The problem point identifying unit 460 may employ the correction method in which the analysis result is satisfactory (for example, in which the number of identified components is smaller). For example, in the case of selecting a certain correction method, when identification of a problem point is insufficient (sufficient narrowing is impossible), such as when many components are identified as problem points continuously as an analysis result, the problem point identifying unit 460 can perform re-analysis through another correction method.

Since an inconsistent state can be removed by single execution of correction processing, the problem point identifying unit 460 does not need to repeatedly perform the same correction method several times when the inconsistent state is detected.

Next, the problem point identifying unit 460 performs correction on the path information by using the selected correction method (for example, (Method II) because the number of functions: 4<the number of components: 5 in the example of FIG. 50) (processing P182). For example, as illustrated in the lower end of FIG. 46, the problem point identifying unit 460 deletes a component p4 of a function F2.

The problem point identifying unit 460 performs analysis by using the path information after correction and identifies a problem point (processing P183). In the example of FIG. 50, as illustrated in the lower end of FIG. 46, the problem point identifying unit 460 deletes the component p4 as a problem point.

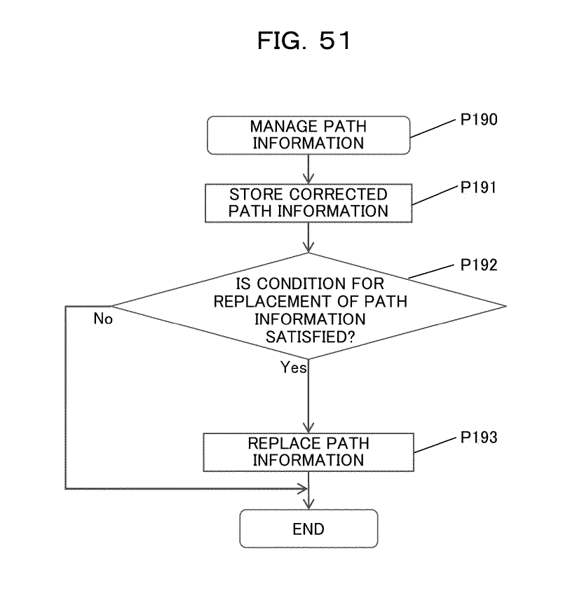

In addition, the problem point identifying unit 460 can perform management of the path information on which correction is performed after identification of a cause component (see processing P190 in FIGS. 5 and 51).

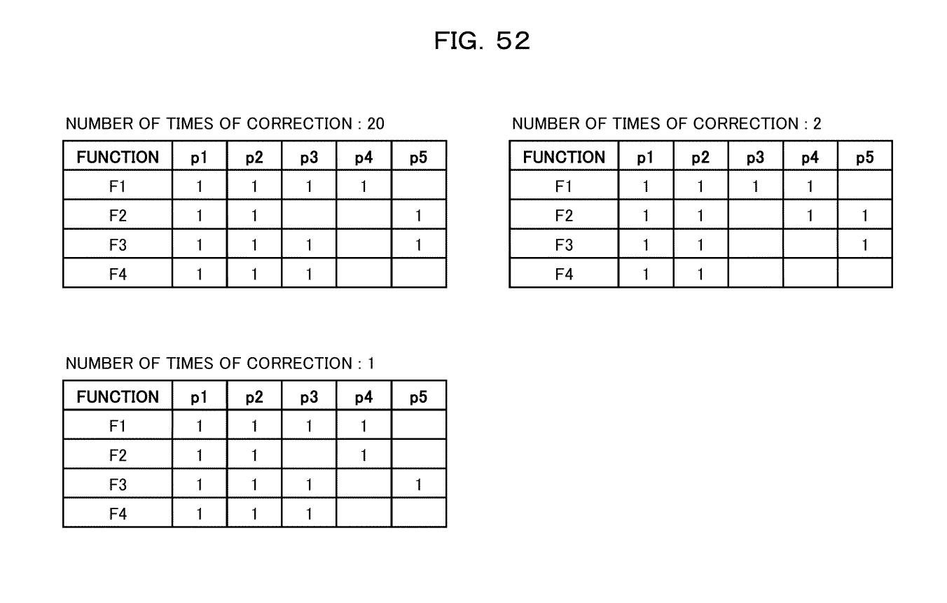

For example, as illustrated in FIG. 51, the problem point identifying unit 460 accumulates the corrected path information in a memory, such as RAM, or in a storage device, such as a hard disk device (processing P191). In this case, the problem point identifying unit 460 may record a correction frequency (for example, the number of times of correction) in each path information corrected with the same pattern. In the example of FIG. 52, the number of times of correction of a pattern in which p4 is deleted from F2 is 20, the number of times of correction of a pattern in which p3 is deleted from F3 and F4 is 2, and the number of times of correction of a pattern in which p5 is deleted from F2 is 1.

Next, the problem point identifying unit 460 determines whether the accumulated path information after correction satisfies a condition for replacement (processing P192). When the condition for replacement is satisfied (Yes route of processing P192), the problem point identifying unit 460 performs replacement of the path information (processing P193) and processing proceeds to processing P170 of FIG. 5. On the other hand, when the condition for replacement is not satisfied (No route of processing P192), the problem point identifying unit 460 does not perform replacement of the path information and processing proceeds to processing P170 of FIG. 5.

As the condition for replacement, there is a case in which, for example, the number of times of correction of a pattern with the largest number of times of correction is equal to or larger than a predetermined number of times (for example, 15 times), and is equal to or larger than predetermined times (for example, 10 times) the number of times of correction of a pattern with the second largest number of times of correction. In the example of FIG. 52, since the pattern with 20 times of correction appears 15 times or more, and 10 times or more the number of times of correction of the pattern with the second largest number of times of correction of 2, it is determined that the condition for replacement is satisfied. The problem point identifying unit 460 replaces a portion corresponding to the path information stored in the path information database 404 (at least component of function F2) with the pattern with 20 times of correction.

In addition, the condition for replacement of the path information is not limited to the aforementioned condition and several methods can be used.

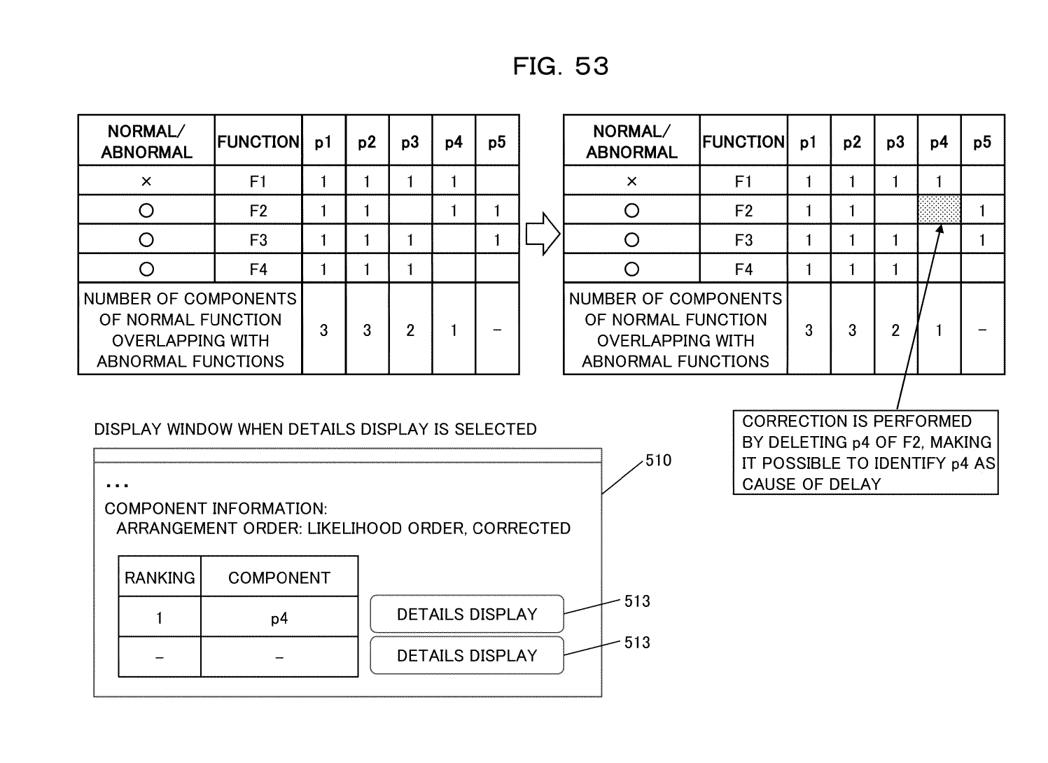

Furthermore, when the problem point is identified (or narrowed), the problem point identifying unit 460 outputs the problem point in the form illustrated in FIG. 9 in processing P170 in FIG. 5. In the example of FIG. 50, the problem point identifying unit 460 can output, as illustrated in FIG. 53, the identified component p4 on a details display window 510.

Even when there is correction of the path information, the problem point identifying unit 460 may omit to notify that there is correction, and therefore, may omit to display an indication of whether there is correction on the details display window 510.

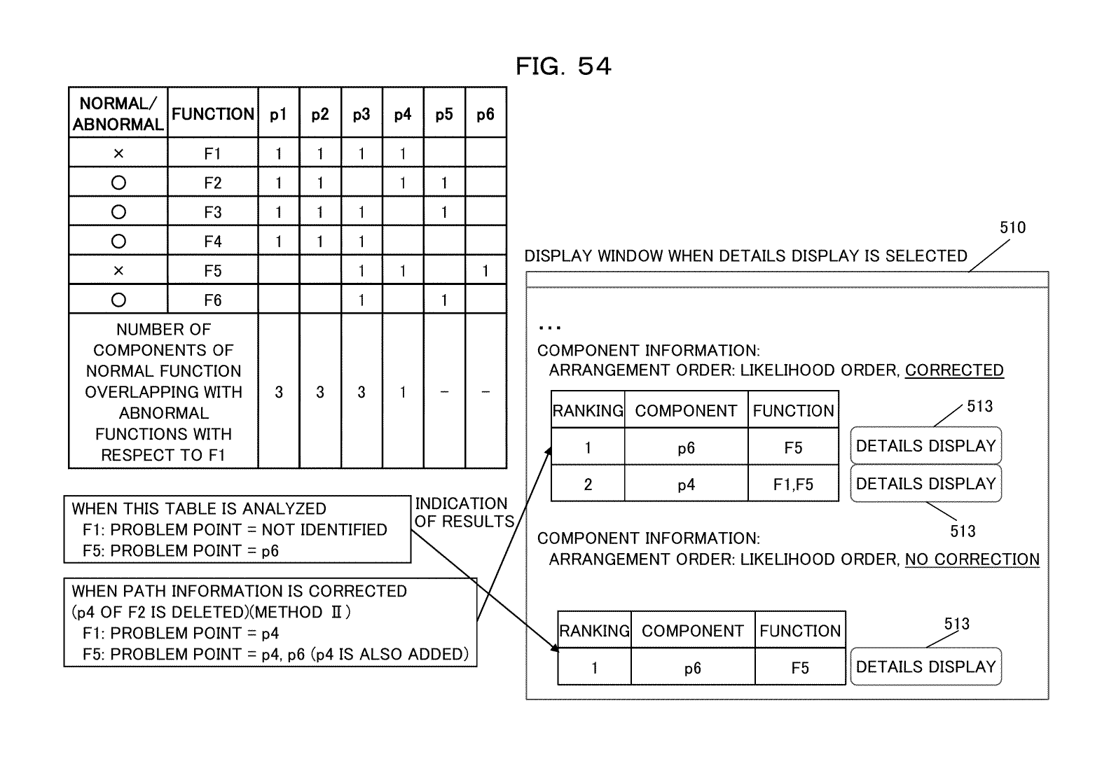

Another output example of the problem point is illustrated in FIG. 54. In a table illustrated in the left side of FIG. 54, the problem point identifying unit 460 identifies p6 as a problem point in an abnormal function F5, but cannot identify p6 as a problem point in an abnormal function F1. In this case, when correction of the path information is performed by (Method II-1), and p4 of a normal function F2 is deleted, p4 is identified as a problem point in the abnormal function F1. At this time, since p4 is also included in the abnormal function F5, problem points of F5 include p4 and p6 due to addition of p4.

In this case, as illustrated in the details display window 510 of the right side of FIG. 54, the problem point identifying unit 460 may indicate results of identifying (narrowing) a problem point depending on presence or absence of correction of the path information. In the example of FIG. 54, a function (abnormal function) which uses an identified cause component may be also output on the details display window 510.

(Another Example 1 of Reliability Used in Correction of Path Information)

In the aforementioned (Method I) or (Method II), there has been described an example of correcting the path information by using the number of components of a normal function overlapping with a delay function (with respect to each component using the delay function, the number of normal functions that use the component) as reliability. The reliability is not limited to what is described above and may include, for example, the following information.

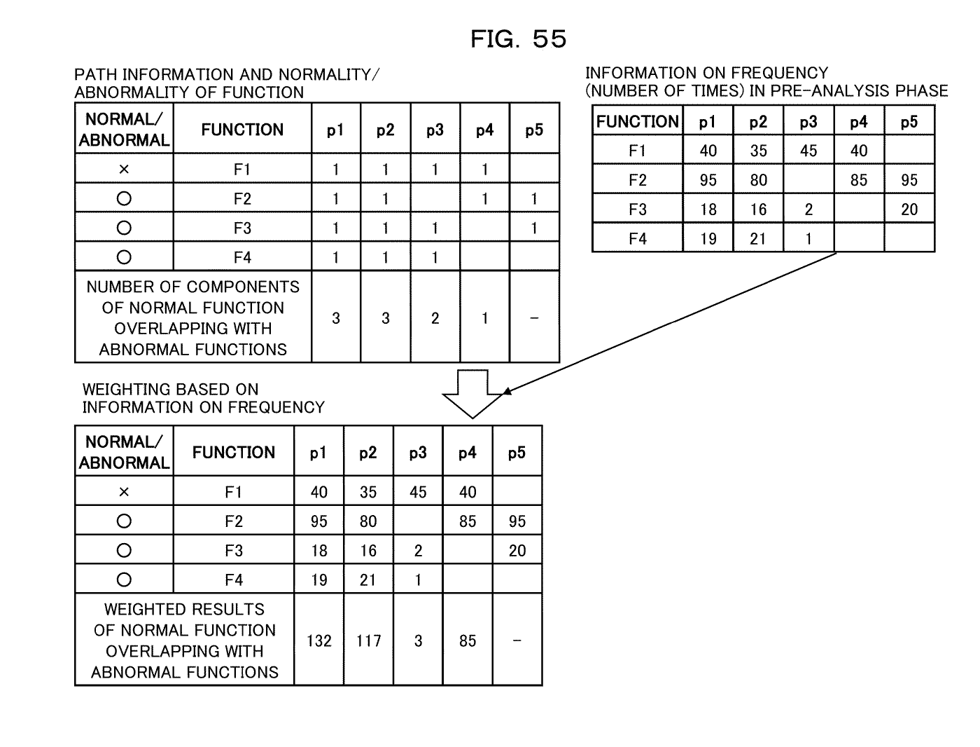

In the upper right side of FIG. 55, a frequency (the number of times, for example, the total number) of a component used in the pre-analysis phase is information indicated by each function. The problem point identifying unit 460 performs weighting based on frequency (the number of times) information with respect to a table representing the path information and a state of whether each function is normal or abnormal (the upper left side of FIG. 55). Therefore, as illustrated in the lower side of FIG. 55, it is possible to obtain reliability by adding a frequency, at which a normal function is used, with respect to each component which an abnormal function uses. As an example, p1 has a reliability of 95 (F2)+18 (F3)+19 (F4)=132.

In the pre-analysis phase, the pre-analysis block 401 may count a frequency (the number of times) of a component used whenever a function is called, with respect to each component of each function, and store the frequency as frequency information.

Correction of the path information based on the example (Method II) of FIG. 46 is a result of using the number of components as reliability and deleting p4 of F2. In this regard, in the example of FIG. 55, when the frequency information in the pre-analysis phase is considered as a weight, the reliability of p3 of F3 and F4 becomes 3, resulting in the lowest reliability (considerably low). In addition, “considerably low” may mean that it is lower than the second lowest reliability (or an average of all reliabilities or the like) by more than a predetermined value (for example, 15) or a predetermined rate (for example, 1/10), that is, is as low as not being an error.

In this case, the problem point identifying unit 460 may identify p3 instead of p4 in the abnormal function F1 by using F3=p1-p2-p5, and F4=p1-p2, resulting from deleting p3 from the normal functions F3 and F4 respectively, as the path information after correction. Based on the identified result, a pattern (pattern of FIG. 43A) is estimated in which the functions F3 and F4 use P3 in the pre-analysis phase but do not use p3 in the operation phase.

As described above, it is possible to perform high reliable analysis and improve analysis precision by performing weighting on a reliability by using frequency information representing how often a normal function uses a component used by an abnormal function.

In the example of FIG. 55, when the reliability of p4 is also a considerably low value, such as 5, not 85, the problem point identifying unit 460 may identify p3 and p4 as problem points, and rank and notify the problem points according to an ascending order of reliability.

In addition, the example of FIG. 55 can be applied to (Method I) not (Method II). When the example of FIG. 55 is applied to (Method I), the problem point identifying unit 460 may delete the functions F3 and F4 which use p3 based on the reliabilities.

(Another Example 2 of Reliability Used in Correction of Path Information)

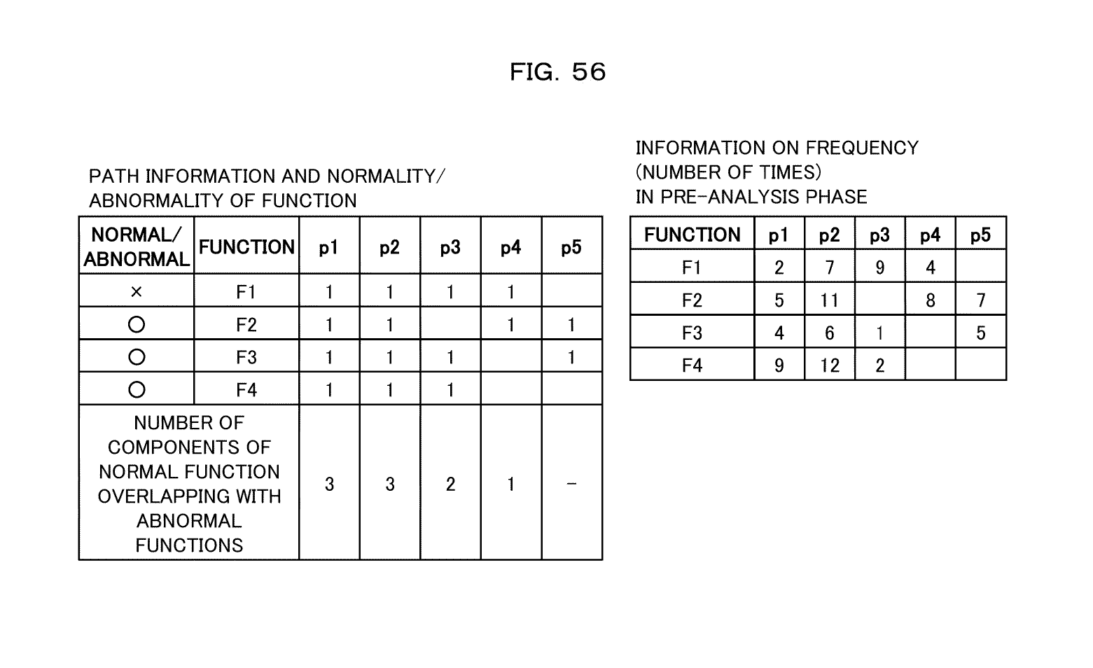

Although whether a component is used or not is used as frequency information every time when a function Fi is called in the pre-analysis phase in the example of FIG. 55, as illustrated in FIG. 56, which times the component is used when the function Fi is called once may be used as frequency information.

Depending on systems, there is a case where, when a function is called once, the same component is used a plurality of times. The pre-analysis block 401 may count the frequency (the number of times) thereof with respect to each component of each function, and store the frequency as the frequency information.

In addition, since a method for calculation of reliability and correction of path information based on the frequency information illustrated in FIG. 56 is similar to the method described with reference to FIG. 55, a description thereof will be omitted.

Even in the example of FIG. 56, similarly to the example of FIG. 55, it is possible to perform more high reliable analysis and improve analysis precision.

(Another Example 1 of Correction Processing of Path Information)

The problem point identifying unit 460 may delete all deletion component candidates when there is no significant difference in a reliability of a component which is the deletion candidate (correction candidate).

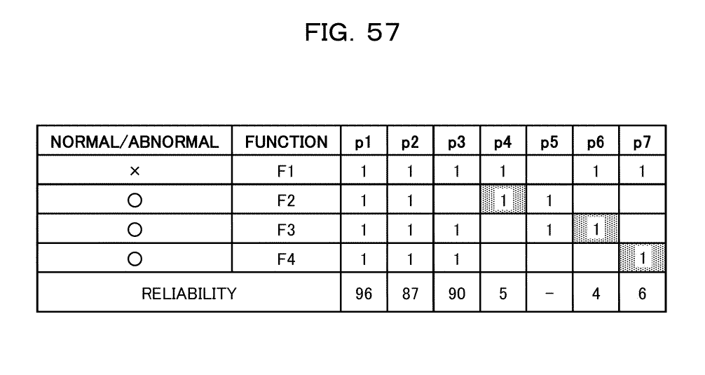

For example, as illustrated in FIG. 57, when all of p4 of F2, p6 of F3, and p7 of F4 are compared with p1 to p3, the difference therebetween is considerably low, but there is no significant difference among p4, p6, and p7. In this case, the problem point identifying unit 460 may delete all of p4, p6, and p7.

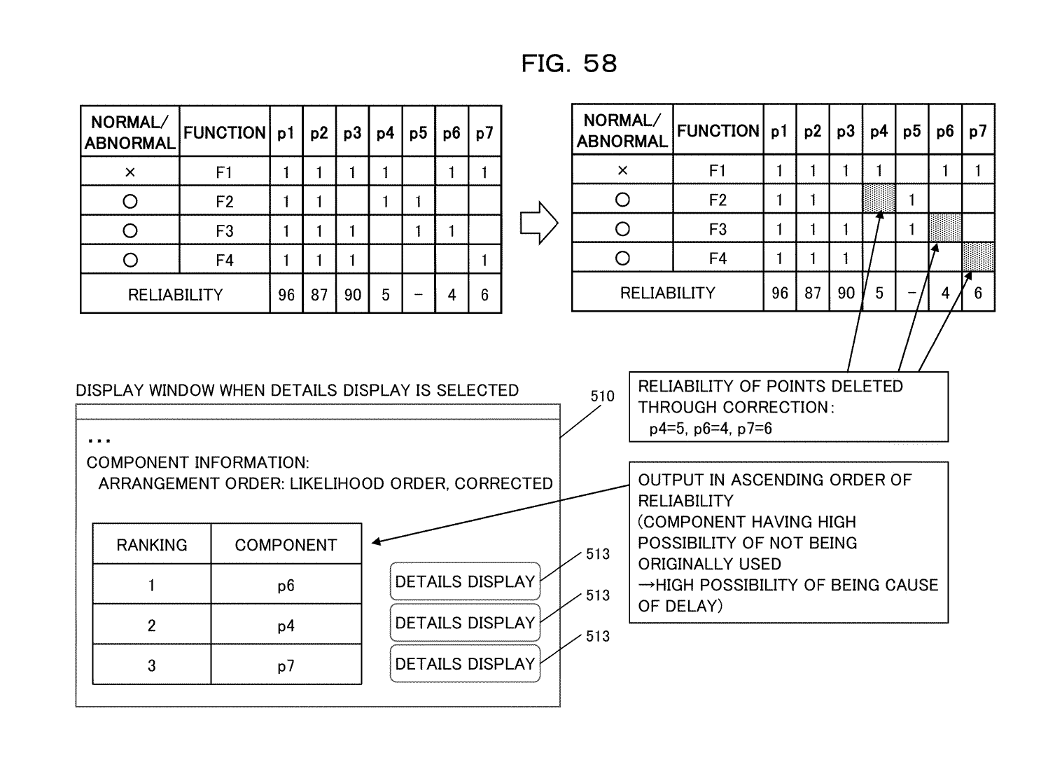

In addition, in a case where there is not significant difference in reliability of a plurality of components which are narrowed as a problem point, the problem point identifying unit 460, as illustrated in FIG. 58, may perform output according to an ascending order of reliability, that is, a descending order of likelihood which is a delay cause.

Since there is a high possibility that a component having a low reliability isn't originally used and is a delay cause, it is possible to output analysis result having high adequacy by ranking and outputting cause components as in the example of FIG. 58 according to reliabilities thereof.

Even when there is no significant difference between reliabilities of deletion candidate components, it is possible to limit deletion targets by previously setting an upper limit of components to be deleted. In the case of the example of FIG. 57, deletion candidates are p4 of F2, p6 of F3, and p7 of F4, but when the upper limit for deletion is set to 2, the problem point identifying unit 460 may delete p6 of F3 and p4 of F2 according to an ascending order of reliability.

In addition, in addition to designation of an upper limit of components to be deleted, it is possible to set a deletion condition, such as a reference to determine whether there is a significant difference or a reference to determine the number of deletions, resulting in limitation of deletion targets.

Examples according to (Method II) have been described until now. Similarly, with respect to (Method I), in a case where there is no significant difference in reliability of components of deletion candidates, all functions of deletion candidates may be deleted or targets or functions of deletion targets may be limited.

(Another Example 2 of Correction Processing of Path Information)

When the correction rate of the path information before and after correction exceeds a designated value, the problem point identifying unit 460 may suppress the processing of correcting the path information even when detecting an inconsistent state.

The correction rate can be calculated as described below, for example.

Calculation of Whole
The number of corrections/the number of components in functions

Calculation of Each Function Fi
The number of corrections in Fi/the number of components in Fi

The problem point identifying unit 460 performs calculation for the whole, and when a rate resulting from the calculation (correction rate) exceeds a designated value (for example, 10%), may omit to perform correction processing of the entire path information. In the example of FIG. 57, in a case of the number of corrections=3 (p4 of F2, p6 of F3, and p7 of F4) and the number of components in F1 to F4=19, the correction rate is 15.8%. In this case, since the correction rate exceeds the designated value, the problem point identifying unit 460 suppresses all of the correction processings (deletion) (p4 of F2, p6 of F3, and p7 of F4).

The problem point identifying unit 460 performs, for example, calculation for each function Fi, and when a rate of a calculation result exceeds a designated value (for example, 20%), may omit to perform correction processing of the path information with respect to a corresponding function. In the example of FIG. 57, with respect to F2, the number of corrections=1 (p4), the number of components=4, and the correction rate is 25%. In addition, with respect to F3, the number of corrections=1 (p6), the number of components=5, and the correction rate is 20%. Furthermore, with respect to F4, the number of corrections=1 (p7), the number of components=4, and the correction rate is 25%. In this case, since the correction rate of F3 does not exceed the designated value and the correction rates of F2 and F4 respectively exceed the designated value, the problem point identifying unit 460 deletes p6 of F3 and suppresses correction processings (deletion) of F2 and F4.

In both the aforementioned examples, when the correction rate is as large as exceeding the designated value, an effect of correction of the path information on the path information as reference information increases. In addition, a possibility that all correction target components are problem points in practice decreases as the number of correction target components (the number of non-narrowed components) increases.

Therefore, when the correction rate exceeds the designated value, it is possible to improve precision of an analysis result by decreasing a possibility that imprecise (misled) analysis result is output.

In addition, (Method I) can be applied to the aforementioned example, not the described (Method II).

(Another Example 3 of Correction Processing of Path Information)

Even when the correction rate exceeds the designated value in the aforementioned example, it may be possible to find out whether correction target components at the this time (correction pattern) are reasonable, that is are all problem points, by records of accumulation of the path information after correction and a correction frequency (the number of times of corrections).

In other words, even when the correction rate exceeds the designated value, the problem point identifying unit 460 may perform the correction processing of the path information and accumulate the path information after correction in a memory, a storage device, or the like. In a case where a correction pattern of a case in which the correction rate exceeds the designated value is reasonable, as the operation block 402 operates, the number of times of correction of a correction pattern increases, and replacement of the path information is performed.

In this case, the problem point identifying unit 460 may suppress identification of a problem point through the path information after correction and output of an identification result, and output only a result of narrowing by the path information before correction.

(Another Example 4 of Correction Processing of Path Information)

Instead of correction of the path information by the aforementioned (Method I) or (Method II), the following (Method III) can be used.

(Method III) The path information is re-generated (corrected) by re-inserting, into a verification environment, a user request which occurs during a predetermined time interval including a timing at which an inconsistent state in which a problem point cannot be identified is detected.

For example, the operation block 402 captures a request packet always even in the operation phase. In addition, the pre-analysis block 401 obtains a detailed log by re-enacting an access in the verification environment (pre-analysis phase) and re-generates the path information by using capture data around timing at which the operation block 402 detects an inconsistent state.

The problem point identifying unit 460 may update the path information of the path information database 404 by the re-generated path information and accumulate the path information in the memory or the storage device as described above.

Therefore, since the path information for a component which actually uses a function causing an inconsistent state is re-generated, the problem point identifying unit 460 can accurately and easily identify the problem point by using the re-generated path information.

As described above, it is possible to identify the problem point and improve precision of the analysis result by re-enacting an access in the case of detecting the inconsistent state and re-generating the path information.

In addition, the aforementioned example may be performed by any combination of (Method I) to (Method III).

As described above, the problem point identifying unit 460 according to an embodiment corrects path information related to each processing performed during a predetermined time interval based on a predetermined condition even when the problem point is not identified in a processing of identifying a problem point. The problem point identifying unit 460 identifies an abnormal component by using a result of determining an abnormal or normal state and the corrected path information. Accordingly, it is possible to identify an abnormal component even when information on components through which each of a plurality of processings passes is incorrect, resulting in reduction in time used to resolve a problem when failure/trouble occurs.

According to an embodiment, it is possible to identify an abnormal module even when information on modules through which each of a plurality of processings passes is incorrect.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A computer-readable recording medium having stored therein an analysis program for causing a computer to execute a process, the process comprising:
storing information on modules through which each processing passes with respect to each of a plurality of processings in which shared modules exist;
determining a normal or abnormal state of each of the processings which are performed during a predetermined time interval based on log information related to the plurality of processings which are performed during the predetermined time interval;
correcting the information on the modules according to each of the processings which are performed during the predetermined time interval, based on a predetermined condition, when an abnormal module is not identified in a process of identifying the abnormal module by using a determination result of the normal or abnormal state and the information on the modules according to each of the processings which are performed during the predetermined time interval; and
identifying the abnormal module by using the determination result of the normal or abnormal state and the corrected information on the modules.

2. The computer-readable recording medium according to claim 1, wherein the correcting of the information on the modules comprises deleting information related to at least one processing from the information on the modules according to each of the processings which are performed during the predetermined time interval.

3. The computer-readable recording medium according to claim 1, wherein the correcting of the information on the modules comprises deleting information on at least one module of modules through which, with respect to at least one processing, the process passes, from the information on the modules according to each of the processings which are performed during the predetermined time interval.

4. The computer-readable recording medium according to claim 1, wherein the correcting of the information on the modules comprises adding information on at least one module to information on modules through which, with respect to at least one processing, the process passes, from the information on the modules according to each of the processings which are performed during the predetermined time interval.

5. The computer-readable recording medium according to claim 1, the process further comprising:
calculating an evaluation value indicating possibility that, with respect to each of abnormal module candidates through which a processing determined as an abnormal state in the determination passes, a processing determined as a normal state in the determination passes through the abnormal module candidates, based on the information on the modules according to each of the processings which are performed during the predetermined time interval; and
determining a correction target processing or a correction target module for the correction based on the evaluation value from the information on the modules according to each of the processings which are performed during the predetermined time interval.

6. The computer-readable recording medium according to claim 5, wherein the evaluation value is weighted based on information on a frequency with which the processing determined as the normal state in the determination passes through each of the abnormal module candidates.

7. The computer-readable recording medium according to claim 1, the process further comprising:
storing a user request according to a plurality of processings which are performed during the predetermined time interval; and
reperforming the stored user request when the abnormal module is not identified in the process of identifying the abnormal module,
wherein the correcting of the information on the modules includes regenerating information on modules through which each of the processings performed during the predetermined time interval passes, from a reperformance result.

8. The computer-readable recording medium according to claim 1, the process further comprising replacing the stored information on the modules with the corrected information on the modules when the corrected information on the modules satisfies a replacement condition.

9. An analysis apparatus comprising:
a processor configured to
store information on modules through which each processing passes with respect to each of a plurality of processings in which shared modules exist;
determine a normal or abnormal state of each of the processings which are performed during a predetermined time interval based on log information related to the plurality of processings which are performed during the predetermined time interval;
when the abnormal module is not identified in a process of performing identification of an abnormal module by using the determination result of the normal or abnormal state and the information on the modules according to each of the processings which are performed during the predetermined time interval, correct the information on the modules according to each of the processings which are performed during the predetermined time interval, based on a predetermined condition; and
identify the abnormal module by using the determination result of the normal or abnormal state and the corrected information on the modules.

10. An analysis method comprising:
storing information on modules through which each processing passes with respect to each of a plurality of processings in which shared modules exist;
determining a normal or abnormal state of each of the processings which are performed during a predetermined time interval based on log information related to the plurality of processings which are performed during the predetermined time interval;
correcting the information on the modules according to each of the processings which are performed during the predetermined time interval, based on a predetermined condition, when an abnormal module is not identified in a process of identifying the abnormal module by using a determination result of the normal or abnormal state and the information on the modules according to each of the processings which are performed during the predetermined time interval; and
identifying the abnormal module by using the determination result of the normal or abnormal state and the corrected information on the modules.
